(19) United States
(12) Patent Application Publication
(10) Pub. No.: US 2024/0060940 A1
(43) Pub. Date: Feb. 22, 2024

(54) PACKING ASSEMBLY FOR CHROMATOGRAPHY MEDIA AND METHODS OF USE THEREOF

(71) Applicant: McMaster University, Hamilton (CA)

(72) Inventor: Raja Ghosh, Dundas (CA)

(21) Appl. No.: 18/452,936

(22) Filed: Aug. 21, 2023

Related U.S. Application Data
(60) Provisional application No. 63/399,373, filed on Aug. 19, 2022.

(51) Int. Cl. G01N 30/56; B01J 20/282

(52) U.S. Cl. CPC G01N 30/56; B01J 20/282; G01N 2030/562; G01N 2030/521

(57) ABSTRACT

A packing assembly for forming a packed-bed for a chromatography device is described herein. The packing assembly includes a bottom plate and a first top plate. The first top plate has a top plate hole centrally positioned therein. The packing assembly also includes a middle plate. The middle plate has a middle plate hole centrally positioned therein. The middle plate hole is aligned with the top plate hole when the packing assembly is in an assembled state. The packing assembly also includes a second top plate. The second top plate has a protrusion extending outwardly. At least a portion of the protrusion has a same size and a same shape as the top plate hole to be received in the top plate hole when the packing assembly is in a packing state. Methods of packing chromatography media in a packing assembly and assembling a chromatography device are also described herein.

### CROSS-REFERENCE TO RELATED PATENT APPLICATIONS

This application claims the benefit of U.S. Provisional Patent Application No. 63/399,373 filed Aug. 19, 2022. The entire contents of U.S. Provisional Patent Application No. 63/399,373 is hereby incorporated by reference herein for all purposes.

### FIELD

The present disclosure relates to the field of chromatography, and in particular, to a packing assembly for packing chromatography media and methods of use thereof.

### BACKGROUND

Chromatography columns that are operated at medium to high pressures are usually packed by slurry packing methods, since it is very difficult to dry pack of particles in a long tubular structure using techniques such as vibration, “tap-fill”, and mechanical compression is very difficult [1, 2]. Dry packing methods, which are laborious and operator dependent, often result in inefficient and unstable columns [1]. Also, dry packing by vibration and “tap-fill” methods are not very reproducible due to the tendency of the dry particles to clump together [1]. Slurry packing of high-performance liquid chromatography (or HPLC) columns is usually carried out by pumping a “packing solvent” at high pressure to force a slurry of the stationary phase particles into a column fitted with a retaining frit at the outlet [1, 3]. Once the column is packed, the slurry tube is disconnected, a frit is placed on top of the packed material, and the column is capped [1, 3].

Preparative columns used for biological separations are slurry packed using techniques such as dynamic axial compression and flow packing [4-6]. Dynamic axial compression packing involves filling a column with a slurry, followed by compression using a fritted plunger [4-6]. Flow packing, which is largely similar to the technique used for packing HPLC columns (discussed above in 0002), involves the pumping of a slurry into the column, till it is filled [3, 5, 6]. Sometimes, different combinations of dynamic axial compression packing, and flow packing are used to optimize column packing [5, 6].

While slurry packing has been successfully used for many years and is the default method for packing chromatography columns used for purifying biological macromolecules, there are some limitation and challenges [1, 3, 5-7]. To begin with, the choice of the “packing solvent” could become a limiting factor as this has to be matched with the stationary phase particles for chemical compatibility, density, and viscosity, to ensure that these particles do not settle relative to the “packing solvent” [1]. Also, radial segregation of particles, due to size difference could result in very non-uniform packing [1]. Columns are usually packed under high pressure and the release of pressure during slurry disconnection and capping could result in problems such rapid decompression [1]. The retaining frits located at the column outlet could also become blocked during high pressure packing [8, 9]. In small scale columns that have significant wall area to bed-volume ratio, the so-called “wall-effects” could become quite significant, and the inner walls of such column need to be very smooth to lower wall friction, and thereby minimize the generation of fine particles by attrition [1, 8, 9]. When using dynamic axial compression and flow packing methods for packing “soft” chromatographic media used for biopharmaceutical purifications, significant differences in packing density along the bed-height, and porosity in the radial direction have been reported [5, 6]. Also, slurry packing of particles smaller than 2 μm is extremely difficult, due to a variety of factors [1,10,11].

Resolution in chromatographic separation is critically dependent on the size and homogeneity of the stationary phase particles packed in a column. High-resolution separations can be obtained using mono-dispersed ultrafine particles. There are several reports on the use of particles in the sub-2 μm range for high-resolution separations [1, 10, 11]. However, columns packed with such media operate at extremely high pressures. This necessitates the use of ultra-high pressure liquid chromatography systems, which are very expensive [11]. Some of the other challenges with ultrafine chromatographic media include frictional heating and extra-column band-broadening [12]. Frictional heating could result in the lowering in separation efficiency by altering physicochemical properties such as diffusivity and viscosity [13]. With temperature sensitive molecules such as proteins, frictional heating could result in on-column degradation and aggregation [14]. Also, as mentioned earlier, ultrafine chromatographic media is difficult to pack in columns [1, 9, 11].

Hydroxyapatite particles are widely used for chromatographic separation of proteins and other types of biomolecules [15-18]. Hydroxyapatite occurs naturally in biological tissues, e.g., bone. Therefore, it is more biocompatible than the synthetic resin particles that are more commonly used for chromatographic separation. Most reports on the use of hydroxyapatite for biological separations are based on particles having diameter in the tens of micron range. Conceivably, the resolution in separation obtained in hydroxyapatite-based chromatography could be increased by using finer particles. Hydroxyapatite nanoparticles are widely used for a range of biomedical applications [19]. However, it is not possible to directly pack such nanoparticles within conventional columns [20]. Protein separation using monolith columns in the capillary format, prepared by the incorporation of hydroxyapatite nanoparticles within a polymer scaffold, has been reported [20]. Typical protein separation time reported in this paper ranged from 5-10 minutes [20]. Potential disadvantages of using this approach would include the additional steps required for monolith preparation, and the lowering of protein binding capacity due the “dilution” of the active binding material, i.e. hydroxyapatite, by the scaffold polymer. Also, the use of the capillary format would result in very high pressure drop across the chromatography device. The structure of large molecules such as proteins and nucleic acids could potentially be affected by ultra-high pressure [14]. Also, chromatographic media used for biological separations (including hydroxyapatite) are frequently soft and deformable, and therefore likely to compact at high pressures. A device that allows more direct and uncomplicated use of the hydroxyapatite nanoparticles would therefore be more desirable.

In a recent paper, protein separation using a short bed-height (i.e. 3 mm) cuboid packed-bed chromatography device, slurry packed with hydroxyapatite nanoparticles has been reported [21]. Using this device, proteins such as monoclonal antibodies could be separated at low pressure (0.27-0.75 MPa) in 2-4 minutes. The design of the cuboid packed-bed chromatography device reported in the paper was based on that of a laterally-fed membrane chromatography (LFMC) device [22-25]. This format was selected to reduce macroscale convective dispersion, typically is associated with chromatography devices having large frontal areas compared to their bed-heights [26-28]. The use of the short bed-height cuboid device allowed the separation to be carried out at low pressure. The use of the hydroxyapatite nanoparticles (in the (120-200 nm range) contributed towards increasing the speed and improving the resolution in protein separation [21]. The small size and size-distribution of the stationary phase particles ensured that dispersion effects within the packed-bed were low, and sharp flow-through and eluted peaks were thereby obtained. [21]. However, filling these nanoparticles in the cuboid device using a slurry packing method proved very challenging and time consuming. It required very meticulous handling skills, which would make it difficult to translate this technology for wider applications. Therefore, there is a need for improved methods for packing nanoparticles for chromatography.

Ceramic hydroxyapatite (CHT) multimodal chromatographic media is micron-sized media commonly used for separation of proteins such as monoclonal antibodies [17, 29]. CHT has been shown to be particularly suitable for the separation of monoclonal antibody aggregates [17, 30-33]. More recently, the use of CHT for purification of viruses, including those that are used for therapeutic applications has been reported [34, 35]. The mixed- or multi-modal binding behavior of hydroxyapatite is due to the presence of calcium (C-site) which binds proteins and other biological macromolecules through metal ion affinity mechanism, and the negatively charged phosphate component (P-site) which binds species through a cation exchange mechanism [29, 36]. Antibodies bind to CHT close to, or slightly below neutral pH, primarily due to cation exchange mechanism to the P-site, with the C-site having a secondary role [36].

CHT is typically packed into columns by slurry packing [37, 7]. This includes subtypes of slurry packing such as dynamic axial packing and flow packing which are well-established methods. While slurry packing is considered the default method for packing columns used for bio-chromatography [1, 3, 5, 6] there are some major challenges. The choice of liquid medium used for preparing the slurry could be limited by factors such as density, chemical compatibility, and viscosity [1]. Also, polydispersity in particle size could result in radial or axial segregation of particles during packing, leading to non-uniform packed-beds which perform sub-optimally [1]. Significant differences in porosity in the radial direction and packing density along the bed-height have been reported for slurry packed columns [5, 6]. Columns are typically slurry packed under pressure, and rapid decompression which happens during column capping could disturb the packing [18]. Retaining frits used in the column could also get blocked during the slurry packing process [8, 38]. The attrition during the packing process due to pumping and other manner of material handling could also result in the generation of fine particles which could reduce the efficiency of chromatographic separations [1, 8, 38]. CHT particles are particularly susceptible to fracture during slurry packing into columns [37,39].

Commercial CHT media is available in both powdered and pre-suspended forms. CHT powder is usually suspended in an appropriate liquid medium to obtain a slurry, which is then packed into a column using dynamic axial packing or flow packing [40]. If the powder could somehow be directly packed into a column, some of the problems associated with slurry packing could potentially be avoided. While dry packing methods for packing high performance liquid chromatography columns have been reported, these tend to be laborious and are not very reproducible [1]. Consequently, they are rarely used in bio-chromatography.

Accordingly, there is a need for new and improved packing assemblies for chromatography media and packing methods and methods of use thereof.

The background herein is included solely to explain the context of the disclosure. This is not to be taken as an admission that any of the material referred to was published, known, or part of the common general knowledge as of the priority date.

### SUMMARY

In accordance with a broad aspect, a packing assembly for forming a packed-bed for a chromatography device is described herein. The packing assembly includes a bottom plate and a first top plate defining a top plate hole centrally positioned in the first top plate. The packing assembly also includes a middle plate defining a middle plate hole centrally positioned in the middle plate. The middle plate hole is aligned with the top plate hole when the packing assembly is in an assembled state where the middle plate is coupled to each of the bottom plate and the first top plate and the middle plate is positioned between the bottom plate and the first top plate. The packing assembly also includes a second top plate. The second top plate has a protrusion extending outwardly. At least a portion of the protrusion has a same size and a same shape as the top plate hole to be received in the top plate hole when the packing assembly is in a packing state.

In at least one embodiment, the protrusion has an upper end and a lower end. The lower end has a lower surface that is coplanar with a lower surface of the first top plate when the packing assembly is in the packing state.

In at least one embodiment, the lower surface of the protrusion is parallel with an upper surface of the bottom plate when the packing assembly is in the packing state.

In at least one embodiment, the protrusion has a height equal to a thickness of the first top plate.

In at least one embodiment, the middle plate hole in the middle plate, the top plate hole in the first top plate, and the protrusion in the second top plate are rectangular or square.

In at least one embodiment, the middle plate hole in the middle plate, the top plate hole in the first top plate, and the protrusion in the second top plate are circular.

In at least one embodiment, the middle plate hole has a diameter of about 10 mm to about 500 mm.

In accordance with another broad aspect, a method of packing chromatography media in a packing assembly to form a packed-bed is described herein. The method includes placing the chromatography media in the packing assembly when the packing assembly is in an assembled state. The packing assembly includes a bottom plate and a first top plate defining a top plate hole centrally positioned in the first top plate. The packing assembly also includes a middle plate defining a middle plate hole centrally positioned in the middle plate. The middle plate hole is aligned with the top plate hole when the packing assembly is in an assembled state where the middle plate is coupled to each of the bottom plate and the first top plate and the middle plate is positioned between the bottom plate and the first top plate. The packing assembly also includes a second top plate. The second top plate has a protrusion extending outwardly. At least a portion of the protrusion has a same size and a same shape as the top plate hole to be received in the top plate hole when the packing assembly is in a packing state. The method also includes inserting the protrusion of the second top plate into the top plate hole and applying a force to the second top plate to put the packing assembly into the packing state and compress the chromatography media into the middle plate hole to form the packed-bed in the middle plate.

In at least one embodiment, applying the force to the second top plate compresses the chromatography media between a lower end of the protrusion and an upper surface of the bottom plate. The lower end of the protrusion and the upper surface of the bottom plate are parallel with each other.

In at least one embodiment, applying the force to the second top plate provides for the packed-bed to have a thickness that is less than its length and/or width and/or diameter.

In at least one embodiment, applying the force to the second top plate provides for the packed-bed to a volume of about 0.1 mL to about 1000 mL.

In at least one embodiment, the force applied to the second top plate is about 10 N to about 100 N.

In at least one embodiment, the chromatography media comprises nanoparticles and/or microparticles.

In at least one embodiment, the chromatography media comprises Sephadex, Amberlite, silica gel, aluminum oxide and/or hydroxyapatite.

In at least one embodiment, the chromatography media is hydroxyapatite.

In accordance with another broad aspect, a method of assembling a chromatography device is described herein. The method includes placing the chromatography media in the packing assembly when the packing assembly is in an assembled state. The packing assembly includes a bottom plate and a first top plate defining a top plate hole centrally positioned in the first top plate. The packing assembly also includes a middle plate defining a middle plate hole centrally positioned in the middle plate. The middle plate hole is aligned with the top plate hole when the packing assembly is in an assembled state where the middle plate is coupled to each of the bottom plate and the first top plate and the middle plate is positioned between the bottom plate and the first top plate. The packing assembly also includes a second top plate. The second top plate has a protrusion extending outwardly. At least a portion of the protrusion has a same size and a same shape as the top plate hole to be received in the top plate hole when the packing assembly is in a packing state. The method also includes inserting the protrusion of the second top plate into the top plate hole and applying a force to the second top plate to put the packing assembly into the packing state and compress the chromatography media into the middle plate hole to form the packed-bed in the middle plate. The method also includes disassembling the packing assembly to separate the middle plate from the bottom plate and the first top plate and placing the middle plate with the packed-bed in the chromatography device.

In at least one embodiment, the chromatography device comprises a laterally-fed membrane chromatography device.

In at least one embodiment, the chromatography device comprises an axially-fed membrane chromatography device.

In at least one embodiment, the method is used for assembling a chromatography device for separation and/or purification of molecules in a fluid mixture.

In at least one embodiment, the method is used for assembling a chromatography device for performing chemical reactions.

Other features and advantages of the present disclosure will become apparent from the following detailed description. It should be understood, however, that the detailed description and the specific examples, while indicating embodiments of the disclosure, are given by way of illustration only and the scope of the claims should not be limited by these embodiments, but should be given the broadest interpretation consistent with the description as a whole.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1A shows an exploded view of a packing assembly according to at least one embodiment of the disclosure.

FIG. 1B shows a perspective view of a middle plate of the packing assembly of FIG. 1A.

FIG. 1C shows a perspective view of a first top plate of the packing assembly of FIG. 1A.

FIG. 1D shows a perspective view of a second top plate of the packing assembly of FIG. 1A.

FIG. 2A shows a perspective view of a circular middle plate with a circular middle plate hole according to at least one embodiment of the disclosure.

FIG. 2B shows a top view of a circular middle plate with a circular middle plate hole according to at least one embodiment of the disclosure.

FIG. 3A shows a block diagram of a method of packing chromatography media in a packing assembly to form a packed-bed according to at least one embodiment of the disclosure.

FIG. 3B shows pictures of a method of packing chromatography media in a packing assembly to form a packed-bed according to at least one embodiment of the disclosure.

FIG. 3C shows a block diagram of a method of packing a chromatography device according to at least one embodiment of the disclosure.

FIG. 4A shows an exploded view of a flat cuboid chromatography device according to at least one embodiment of the disclosure.

FIG. 4B shows a perspective view of a top flow distribution plate with primary and secondary channels according to at least one embodiment of the disclosure.

FIG. 4C shows a perspective view of a bottom flow distribution plate with primary and secondary channels according to at least one embodiment of the disclosure.

FIG. 4D shows a photograph of an assembled flat z² cuboid chromatography device according to at least one embodiment of the disclosure.

FIG. 5 shows a square packed-bed within a z² cuboid chromatography device with arrows depicting direction of channel flow through primary channels and secondary channels according to at least one embodiment of the disclosure.

FIG. 6A shows a perspective view of a circular header used for assembling a flat column according to at least one embodiment of the disclosure.

FIG. 6B shows a top view of a circular header used for assembling a flat column according to at least one embodiment of the disclosure.

FIG. 7 shows a cuboid flow distribution plate according to at least one embodiment of the disclosure.

FIG. 8 shows a graph of pressure drop at different flow rates through a flat z² cuboid device packed with hydroxyapatite nanoparticles according to at least one embodiment of the disclosure.

FIG. 9A shows a graph of fast separation of BSA and lysozyme using a 1 mL hydroxyapatite nanoparticle packed flat z² cuboid chromatography device with 10 μL feed sample according to at least one embodiment of the disclosure.

FIG. 9B shows a graph of fast separation of BSA and lysozyme using a 1 mL hydroxyapatite nanoparticle packed flat z² cuboid chromatography device with 100 μL feed sample according to at least one embodiment of the disclosure.

FIG. 10A shows a graph of the effect of flow rate on separation of BSA and lysozyme from 10 μL feed sample using a 1 mL hydroxyapatite nanoparticle packed flat z² cuboid chromatography device using 2 mL/min flow rate according to at least one embodiment of the disclosure.

FIG. 10B shows a graph of the effect of flow rate on separation of BSA and lysozyme from 10 μL feed sample using a 1 mL hydroxyapatite nanoparticle packed flat z² cuboid chromatography device using 8 mL/min flow rate according to at least one embodiment of the disclosure.

FIG. 11A shows a graph of the effect of flow rate on separation of BSA and lysozyme from 100 μL feed sample using a 1 mL hydroxyapatite nanoparticle packed flat z² cuboid chromatography device using 2 mL/min flow rate according to at least one embodiment of the disclosure.

FIG. 11B shows a graph of the effect of flow rate on separation of BSA and lysozyme from 100 μL feed sample using a 1 mL hydroxyapatite nanoparticle packed flat z² cuboid chromatography device using 10 mL/min flow rate according to at least one embodiment of the disclosure.

FIG. 12 shows a graph of fast separation of BSA and monoclonal antibody Campath-1H using a 1 mL hydroxyapatite nanoparticle packed flat z² cuboid chromatography device according to at least one embodiment of the disclosure.

FIG. 13A shows a graph of the effect of flow rate on separation of BSA and monoclonal antibody Campath-1H using a 1 mL hydroxyapatite nanoparticle packed flat z² cuboid chromatography device using 2 mL/min flow rate according to at least one embodiment of the disclosure.

FIG. 13B shows a graph of the effect of flow rate on separation of BSA and monoclonal antibody Campath-1H using a 1 mL hydroxyapatite nanoparticle packed flat z2 cuboid chromatography device using 10 mL/min flow rate according to at least one embodiment of the disclosure.

FIG. 14 shows a graph of binding and elution of monoclonal antibody Trastuzumab using a 1 mL hydroxyapatite nanoparticle packed flat z² cuboid chromatography device according to at least one embodiment of the disclosure.

FIG. 15A shows a graph of purification of monoclonal antibody Trastuzumab from mammalian cell culture supernatant using a 1 mL hydroxyapatite nanoparticle packed flat z² cuboid chromatography device according to at least one embodiment of the disclosure.

FIG. 15B shows an image of a Coomassie blue stained non-reducing SDS-PAGE gel obtained with eluate from the Trastuzumab purification process according to at least one embodiment of the disclosure.

FIG. 16 shows a graph of the effect of linear velocity of height equivalent of a theoretical plate (HETP) according to at least one embodiment of the disclosure.

FIG. 17 shows a graph of the effect of linear velocity of plate height (H) according to at least one embodiment of the disclosure.

### DETAILED DESCRIPTION

### I. Definitions

Unless otherwise indicated, the definitions and embodiments described in this and other sections are intended to be applicable to all embodiments and aspects of the present disclosure herein described for which they are suitable as would be understood by a person skilled in the art. It is also to be understood that the terminology used herein is for the purpose of describing particular aspects only and is not intended to be limiting.

The term “dry compression” as used herein refers to the act of applying a force on chromatography media in an absence of a solvent to flatten it.

The term “chromatography media” as used herein refers to any stationary phase particles that are packed within a chromatography device for carrying out chromatographic separations and/or reactions.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

As used in this disclosure, the singular forms “a”, “an” and “the” include plural references unless the content clearly dictates otherwise.

In embodiments comprising an “additional” or “second” component, the second component as used herein is chemically different from the other components or first component. A “third” component is different from the other, first, and second components, and further enumerated or “additional” components are similarly different.

The term “and/or” as used herein means that the listed items are present, or used, individually or in combination. In effect, this term means that “at least one of” or “one or more” of the listed items is used or present.

The abbreviation, “e.g.” is derived from the Latin exempli gratia and is used herein to indicate a non-limiting example. Thus, the abbreviation “e.g.” is synonymous with the term “for example.” The word “or” is intended to include “and” unless the context clearly indicates otherwise.

### II. Products and Methods of the Disclosure

The present disclosure provides dry-compression methods for packing chromatography media using a packing assembly in accordance with certain exemplary embodiments of the disclosure.

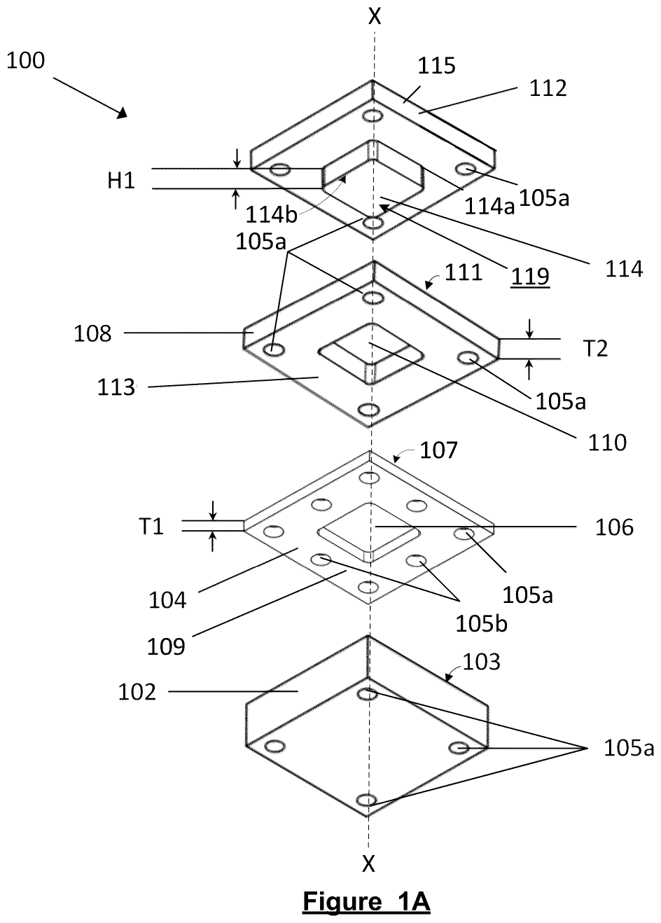

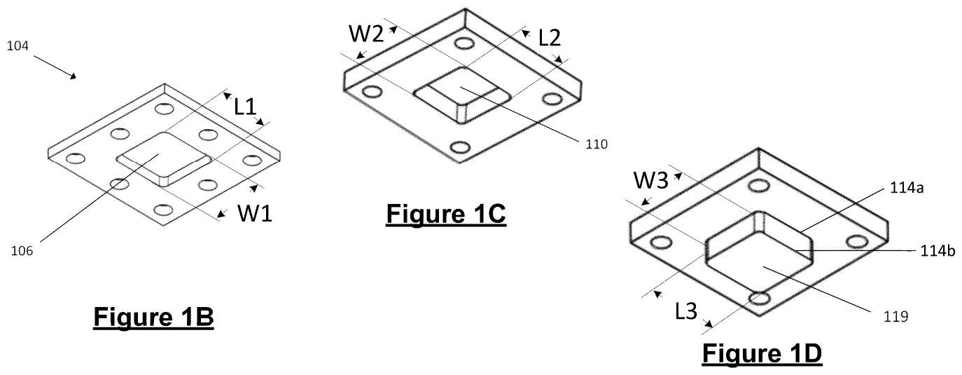

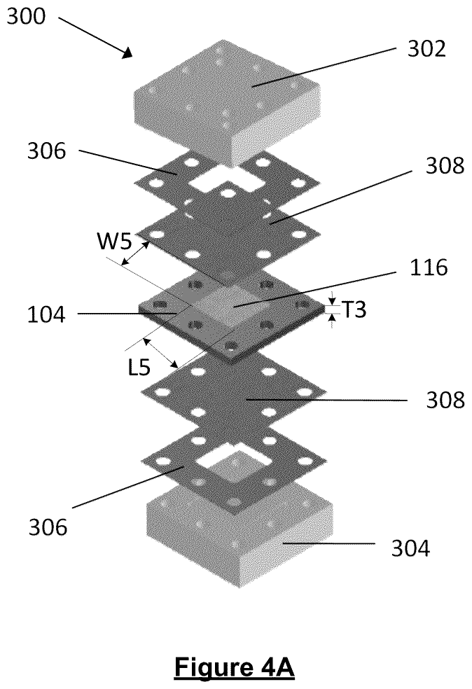

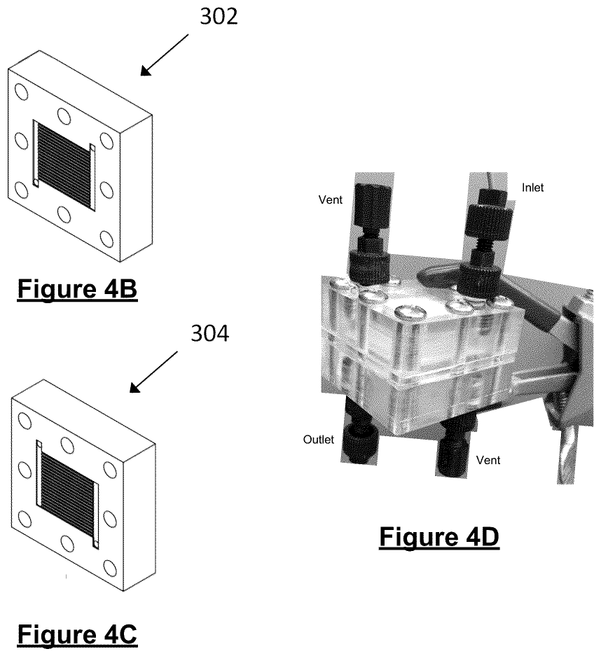

Accordingly, provided herein is a packing assembly 100 for forming a packed-bed 116 for a chromatography device 300, shown in an exemplary embodiment in FIG. 1A. For clarity, a formed packed-bed 116 is shown in FIG. 4A.

The packing assembly 100 includes a bottom plate 102. Bottom plate 102 has an upper surface 103. At least a portion of the upper surface 103 is flat for forming the packed-bed 116 thereon. In at least one embodiment, upper surface 103 is entirely flat. Bottom plate 102 is generally planar in shape. Bottom plate 102 is also configured to be secured to middle plate 104, such as but not limited to by one or more holes 105a therein each sized to receive a fastener, for example, a screw or a bolt.

The packing assembly 100 also includes a middle plate 104. Middle plate 104 is also shown in FIG. 1B. Middle plate 104 is generally planar and has a thickness T1. Middle plate 104 defines a middle plate hole 106. Middle plate hole 106 may be centrally positioned in the middle plate 104, or may otherwise be positioned anywhere within middle plate 104. Middle plate hole 106 extends through the middle plate 104 between an upper surface 107 and a lower surface 109 of the middle plate 104. Middle plate 104 may include one or more holes 105a therein each sized to receive a fastener, for example, a screw or a bolt, for securing the middle plate 104 to the bottom plate 102 and/or the first top plate 108. Additionally, middle plate 104 may include secondary holes 105b for securing the middle plate 104 within a chromatography device.

The packing assembly 100 also includes a first top plate 108. First top plate 108 is also shown in FIG. 1C. First top plate 108 is generally planar and has a thickness T2. First top plate 108 defines a top plate hole 110 centrally positioned in the first top plate 108. Top plate hole 110 extends through the first top plate 108 between an upper surface 111 and a lower surface 113 of the first top plate 108.

First top plate 108 is also configured to be secured to middle plate 104, such as but not limited to by one or more holes 105a therein each sized to receive a fastener, for example, a screw or a bolt.

Middle plate hole 106 is configured to be aligned with the top plate hole 110 when the packing assembly 100 is in an assembled state where the middle plate 104 is coupled to each of the bottom plate 102 and the first top plate 108 and the middle plate 104 is positioned between the upper surface 103 of the bottom plate 102 and the lower surface 113 of the first top plate 108. In at least one embodiment, middle plate hole 106 is aligned with the top plate hole 110 along a longitudinal axis XX of the packing assembly 100 when the packing assembly 100 is in the assembled state.

The packing assembly 100 also includes a second top plate 112 having a protrusion 114 extending outwardly from a lid 115. Second top plate 112 is also shown in FIG. 1D. At least a portion of the protrusion 114 has a same size and a same shape as the top plate hole 110. Protrusion 114 is configured to be received in the top plate hole 110 when the protrusion 114 is inserted into the top plate hole 110 and the packing assembly 100 is in a packing state.

Second top plate 112 is also configured to be secured to first top plate 108, such as but not limited to by one or more holes 105a therein each sized to receive a fastener, for example, a screw or a bolt.

Protrusion 114 has an upper end 114a and a lower end 114b. Lower end 114b has a lower surface 119. Lower surface 119 is coplanar with the lower surface 113 of the first top plate 108 when the packing assembly 100 is in the packing state. This provides for forming a packed bed 116 with a planar top surface. Lower surface 119 of the protrusion 114 is parallel with the upper surface 103 of the bottom plate 102 when the packing assembly 100 is in the packing state. This provides for forming a packed bed 116 with a planar bottom surface.

In exemplary embodiments shown in the Figures, protrusion 114 has a height H1 equal to the thickness T2 of the first top plate 108. However, it should be understood that height H1 need not be equal to the thickness T2 of the first top plate 108.

In some embodiments, the middle plate hole 106 in the middle plate 104, the top plate hole 110 in the first top plate 108, and the protrusion 114 in the second top plate 112 is rectangular or square. In some embodiments, the lower end 114b of the protrusion 114 in the second top plate 112 is rectangular or square.

In embodiments where the middle plate hole 106 is rectangular or square, the middle plate hole 106 has a length L1 of about 10 mm to about 500 mm. In some embodiments, the middle plate hole 106 has a length L1 of about 15 mm to about 400 mm, about 15 mm to about 300 mm, about 15 mm to about 200 mm, about 15 mm to about 100 mm, about 15 mm to about 90 mm, about 15 mm to about 80 mm, about 15 mm to about 70 mm, about 15 mm to about 60 mm, about 15 mm to about 50 mm, about 15 mm to about 45 mm, about 15 mm to about 40 mm, about 15 mm to about 35 mm, about 15 mm to about 30 mm, about 15 mm to about 25 mm, or about 20 mm. In some embodiments, the middle plate hole 106 has a length L1 of about 18.3 mm.

In embodiments where the middle plate hole 106 is rectangular or square, the middle plate hole 106 has a width W1 of about 10 mm to about 500 mm. In some embodiments, the middle plate hole 106 has a width W1 of about 15 mm to about 400 mm, about 15 mm to about 300 mm, about 15 mm to about 200 mm, about 15 mm to about 100 mm, about 15 mm to about 90 mm, about 15 mm to about 80 mm, about 15 mm to about 70 mm, about 15 mm to about 60 mm, about 15 mm to about 50 mm, about 15 mm to about 45 mm, about 15 mm to about 40 mm, about 15 mm to about 35 mm, about 15 mm to about 30 mm, about 15 mm to about 25 mm, or about 20 mm. In some embodiments, the middle plate hole 106 has a width W1 of about 18.3 mm.

In some embodiments, the top plate hole 110 has a length L2 equal to the length L1 of the middle plate hole 106. In some embodiments, the top plate hole 110 has a width W2 equal to the width W1 of the middle plate hole 106.

In some embodiments, the protrusion 114 has a length L3 equal to the length L2 of the top plate hole 110. In some embodiments, the protrusion 114 has a width W3 equal to the width W2 of the top plate hole 110.

In some embodiments, the lower end 117 of the protrusion 114 has a length L3 equal to the length L2 of the top plate hole 110. In some embodiments, the lower end 117 of the protrusion 114 has a width W3 equal to the width W2 of the top plate hole 110.

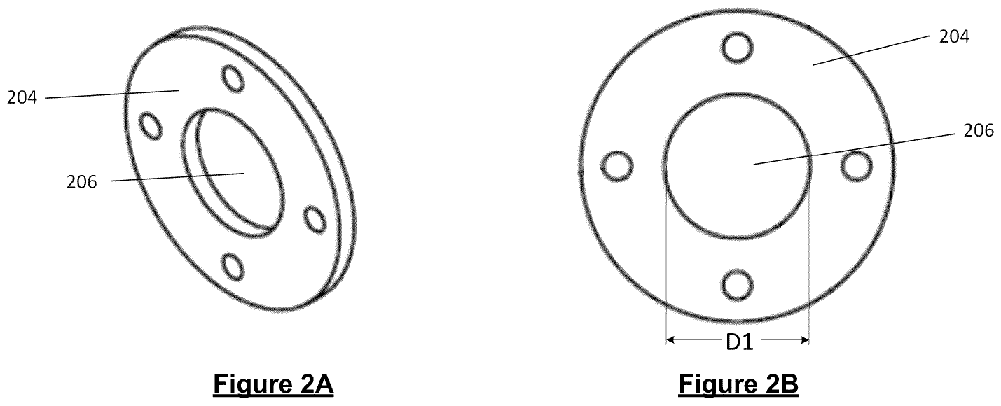

In some embodiments, the middle plate hole 106 in the middle plate 104, the top plate hole 110 in the first top plate 108, and the protrusion 114 in the second top plate 112 is circular. In some embodiments, the lower end 117 of the protrusion 114 in the second top plate 112 is circular. A circular middle plate 204 with a circular middle plate hole 206 is shown in FIG. 2A and FIG. 2B.

In embodiments where the middle plate hole 106 is circular, the middle plate hole 106 has a diameter D1 of about 10 mm to about 500 mm. In some embodiments, the middle plate hole 106 has a diameter D1 of about 15 mm to about 400 mm, about 15 mm to about 300 mm, about 15 mm to about 200 mm, about 15 mm to about 100 mm, about 15 mm to about 90 mm, about 15 mm to about 80 mm, about 15 mm to about 70 mm, about 15 mm to about 60 mm, about 15 mm to about 50 mm, about 15 mm to about 45 mm, about 15 mm to about 40 mm, about 15 mm to about 35 mm, about 15 mm to about 30 mm, about 15 mm to about 25 mm, or about 20 mm. In some embodiments, the middle plate hole 106 has a diameter D1 of about 20.65 mm.

In some embodiments, the top plate hole 110 has a diameter equal to the diameter D1 of the middle plate hole 106.

In some embodiments, the protrusion 114 has a diameter equal to the diameter of the top plate hole 110.

In some embodiments, the lower end 117 of the protrusion 114 has a diameter equal to the diameter of the top plate hole 110.

Packing assembly 100 can be made of any appropriate material. In some embodiments, the packing assembly 100 is made of acrylic.

In some embodiments, the packed-bed 116 comprises a short bed-height. In some embodiments, the packed-bed 116 is generally planar and has a thickness T3 equal to the thickness T1 of the middle plate 104. In some embodiments, the packed-bed 116 has a thickness T3 that is less than length L5 and/or width W5. In some embodiments, the packed-bed 116 has a thickness T3 that is less than diameter D5.

In embodiments where the middle plate hole 106 is rectangular or square, the packed-bed 116 has a length L5 equal to the length L1 of the middle plate hole 106. In embodiments where the middle plate hole 106 is rectangular or square, the packed-bed 116 has a width W5 equal to the width W1 of the middle plate hole 106. In embodiments where the middle plate hole 106 is circular, the packed-bed 116 has a diameter D5 equal to the diameter D1 of the middle plate hole 106.

In some embodiments, the set-up required for dry compression comprises a frame with a rectangular (or square) slot, a base, a frame extension, and a punch. In some embodiments, the frame is first sandwiched between the base and the frame extension and the space within the frame is filled with appropriate amount of hydroxyapatite nanoparticles. In some embodiments, the punch is then lowered within the frame extension, and force is applied to compress and consolidate the particles as a packed-bed 116 within the frame.

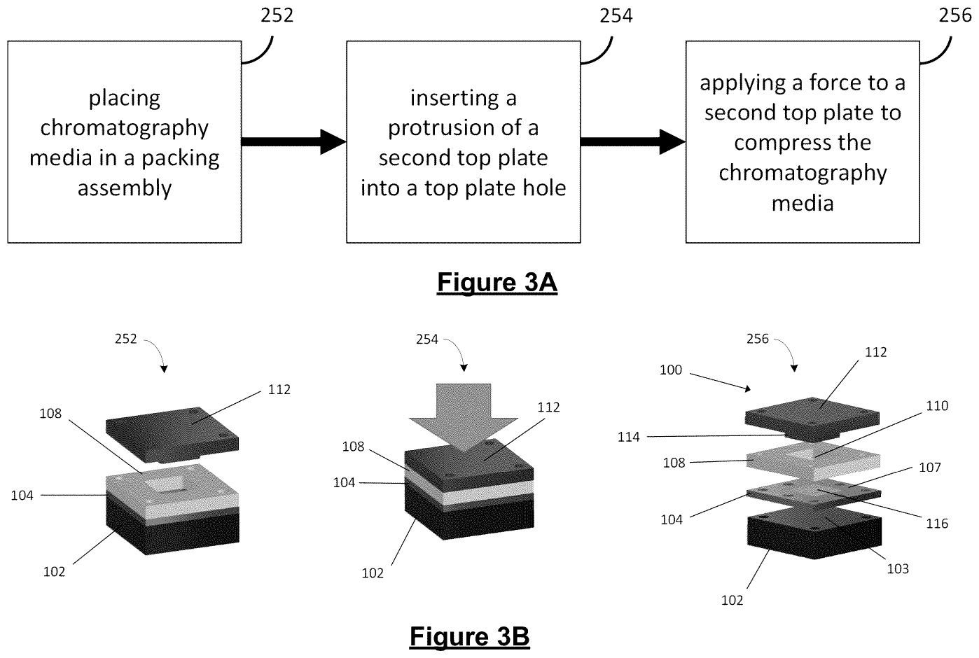

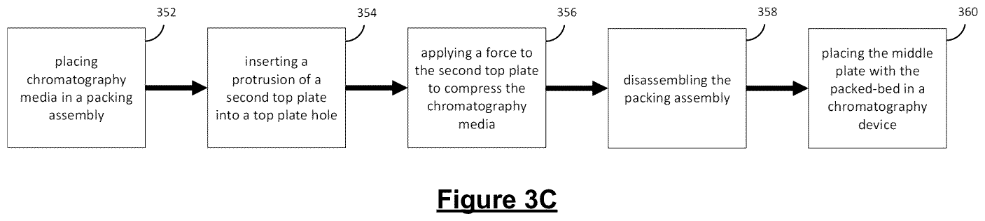

Accordingly, provided herein is a method 250 of packing chromatography media in a packing assembly 100 to form a packed-bed 116 as shown in FIG. 3A.

Method 250 includes, at a first step 252, placing the chromatography media in the packing assembly 100. As noted above, the packing assembly 100 includes a bottom plate 102, a middle plate 104 defining a middle plate hole 106 centrally positioned in the middle plate 104, and a first top plate 108 defining a top plate hole 110 centrally positioned in the first top plate 108. The packing assembly 100 is in an assembled state with the middle plate 104 positioned between the bottom plate 102 and the first top plate 108. The packing assembly 100 also has second top plate 112 having a protrusion 114 extending outwardly. The protrusion 114 has a same size and a same shape as the top plate hole 110 to conform with a perimeter in the top plate hole 110 when the protrusion 114 is inserted into the top plate hole 110. The amount of chromatography media placed in the packing assembly 100 is an appropriate amount to form a packed-bed 116. In embodiments where the middle plate hole 106 is rectangular or square, the packed-bed 116 has a volume according to the length L1, width W1, and thickness T1 of the middle plate hole 106. In embodiments where the middle plate hole 106 is circular, the packed-bed 116 has a volume according to the diameter D1 and thickness T1 of the middle plate hole 106.

In some embodiments, the packed-bed 116 has a volume of about 0.1 mL to about 1000 mL. In some embodiments, the packed-bed 116 has a volume of about 0.2 mL to about 900 mL, about 0.2 mL to about 800 mL, about 0.2 mL to about 700 mL, about 0.2 mL to about 600 mL, about 0.2 mL to about 500 mL, about 0.2 mL to about 400 mL, about 0.2 mL to about 300 mL, about 0.2 mL to about 200 mL, about 0.2 mL to about 100 mL, about 0.2 mL to about 50 mL, about 0.2 mL to about 20 mL, about 0.2 mL to about 10 mL, about 0.3 mL to about 10 mL, about 0.3 mL to about 9 mL, about 0.3 mL to about 8 mL, about 0.3 mL to about 7 mL, about 0.3 mL to about 6 mL, about 0.3 mL to about 5 mL, about 0.4 mL to about 10 mL, about 0.4 mL to about 9 mL, about 0.4 mL to about 8 mL, about 0.4 mL to about 7 mL, about 0.4 mL to about 6 mL, about 0.4 mL to about 5 mL, about 0.5 mL to about 10 mL, about 0.5 mL to about 9 mL, about 0.5 mL to about 8 mL, about 0.5 mL to about 7 mL, about 0.5 mL to about 6 mL, about 0.5 mL to about 5 mL, about 0.6 mL to about 9 mL, about 0.6 mL to about 8 mL, about 0.6 mL to about 7 mL, about 0.6 mL to about 6 mL, about 0.6 mL to about 5 mL, about 0.7 mL to about 8 mL, about 0.7 mL to about 7 mL, about 0.7 mL to about 6 mL, about 0.7 mL to about 5 mL, about 0.8 mL to about 7 mL, about 0.8 mL to about 6 mL, about 0.8 mL to about 5 mL, about 0.9 mL to about 6 mL, about 0.9 mL to about 5 mL, or about 1 mL to about 5 mL. In some embodiments, the packed-bed 116 has a volume of about 1 mL. In some embodiments, the packed-bed 116 has a volume of about 5 mL.

Method 250 includes, at a second step 254, inserting the protrusion 114 of the second top plate 112 centrally positioned therein into the top plate hole 110. As noted above, protrusion 114 is configured to be received in the top plate hole 110 when the protrusion 114 is inserted into the top plate hole 110 and the packing assembly 100 is in a packing state.

Method 250 includes, at a third step 256, applying a force to the second top plate 112 to compress the chromatography media in the middle plate hole 106 to form the packed-bed 116 in the middle plate 104.

In some embodiments, the force to the second top plate 112 is about 10 N to about 100 N. In some embodiments, the force to the second top plate 112 is about 15 N to about 100 N, about 15 N to about 90 N, about 15 N to about 80 N, about 15 N to about 70 N, about 15 N to about 60 N, about 15 N to about 50 N, about 15 N to about 45 N, about 15 N to about 40 N, about 15 N to about 35 N, about 15 N to about 30 N, about 20 N to about 30 N, or about 25 N. In some embodiments, the force to the second top plate 112 is about 24.5 N. An exemplary embodiment of method 250 is shown in FIG. 3B, wherein a packing assembly 100 is configured in an assembled state in first step 252, force is applied to a packing assembly 100 in a packing state in second step 254, and a packed-bed 116 is formed in an exploded view of third step 256.

In some embodiments, after packing the chromatography media, the compression set-up may be disassembled, and the dry-compressed packed-bed 116 thus formed removed. In some embodiments, the packed-bed 116 is used for chromatographic separations and/or reactions.

Accordingly, also provided herein is a method 350 of assembling a chromatography device 300 as shown in FIG. 3C.

Method 350 includes, at a first step 352, placing the chromatography media in the packing assembly 100; at a second step 354, inserting the protrusion 114 of the second top plate 112 centrally positioned therein into the top plate hole 110; and at a third step 356, applying a force to the second top plate 112 to compress the chromatography media in the middle plate hole 106 to form the packed-bed 116 in the middle plate 104, as noted above.

Method 350 also includes, at a fourth step 358, disassembling the packing assembly 100 to separate the middle plate 104 from the bottom plate 102 and the first top plate 108. The middle plate 104 contains the formed packed-bed 116 within the middle plate hole 106. In some embodiments, the packed-bed 116 is retained within the middle plate 104. In some embodiments, the packed-bed 116 is removed from the middle plate 104.

Method 350 also includes, at a fifth step 360, placing the middle plate 104 with the packed-bed 116 in the chromatography device 300.

In some embodiments, the chromatography device 300 comprises a laterally-fed membrane chromatography device.

In some embodiments, the chromatography device 300 comprises an axially-fed membrane chromatography device.

In some embodiments, the chromatography device 300 comprises a short bed-height.

In some embodiments, the chromatography device 300 comprises a flat column chromatography device.

In some embodiments, the chromatography device 300 comprises a flat cuboid chromatography device.

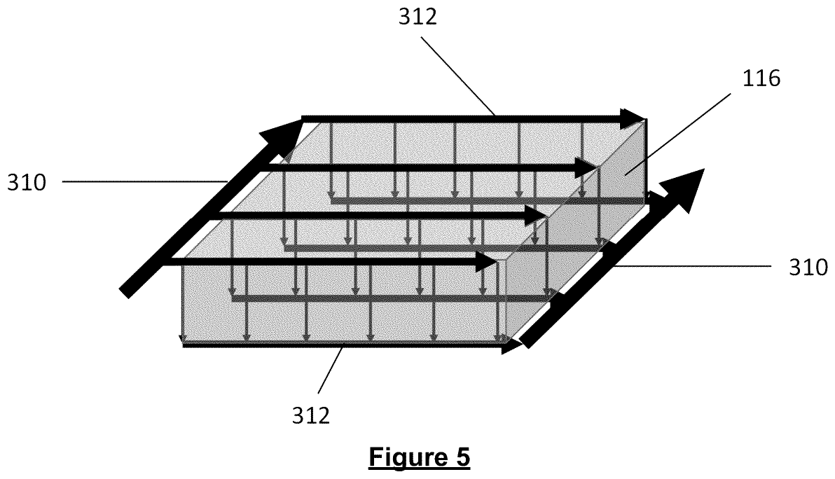

In some embodiments, the packed-bed 116 is sandwiched between a pair of plates (engraved with flow channels), that serve as a distributor plate 302 and collection plate 304 (FIG. 4B and FIG. 4C), respectively. In-between, there is also a gasket 306 next to each plate, each with a hole matching the outline of the dry-compressed packed-bed 116 and a retaining membrane 308 on either side of the packed-bed 116 within the middle plate 104 to construct the flat cuboid chromatography device 300 as shown in FIG. 4A. The packing methods described herein, such as but not limited to packing method 250, may be faster, more reproducible, and less skill-intensive than a typical slurry packing method. Since the previous publication on chromatographic protein separation using hydroxyapatite nanoparticles [21], another version of the cuboid chromatography device 300, i.e. the z² cuboid chromatography device 300 has been described and discussed [27, 28]. The design of the z² cuboid chromatography device 300 minimizes macroscale convective dispersion, increases device scalability, and further improves separation efficiency [27, 28]. The z² cuboid chromatography device 300 utilizes a flow arrangement in which the distribution plate 302 and the collection plate 304 have at least one primary channel 310 located at a slight offset from the packed-bed 116 and a set of secondary channels 312 located above and below to the packed-bed 116 engraved in each plate to direct flow (FIG. 5), which

ensures that the extent of macroscale convective dispersion is low [27], increases device scalability, and improves separation efficiency [27, 28]. Specifically, the liquid entering the chromatography device 300 is distributed to the cuboid packed-bed 116 using a primary channel 310 connected to a set of secondary channels 312 located above the packed-bed 116. The liquid emerging from the packed-bed 116 is collected in a set of secondary channels 312 located below it, from where, it is further directed through a primary channel 310 to the outlet. This type of flow distribution and collection was incorporated in the flat cuboid chromatography device 300 described in the present disclosure. Thereby, the beneficial features of the cuboid chromatography device 300, i.e., low pressure chromatographic separation due to the shallow bed of chromatography media was maintained, while the beneficial features of the z² flow distribution and collection system [27, 28], i.e., low dispersion and high-resolution in separation were added.

In some embodiments, the chromatography media comprises nanoparticles and/or microparticles.

In some embodiments, the chromatography media comprises Sephadex, Amberlite, silica gel, aluminum oxide and/or hydroxyapatite.

In some embodiments, the chromatography media comprises hydroxyapatite nanoparticles.

In some embodiments, commercially sourced hydroxyapatite nanoparticles (200 nm diameter) were packed using the dry-compression method 250 within a frame having a volume of 1 mL (i.e. length=18.3 mm, width=18.3 mm, height=3 mm). The frame was then integrated with a compatible distributor plate 302, collection plate 304, gasket 306 and retaining membrane 308 filters to obtain the flat z² cuboid chromatography device 300. The chromatography device 300 was used for fast analytical separation of model proteins BSA and lysozyme, and BSA and monoclonal antibodies (Campath-1H and Trastuzumab). The utility of this chromatography device 300 for preparative bioseparation was demonstrated through the purification of Trastuzumab from mammalian cell culture supernatant.

In some embodiments, the dry compression packing methods described herein, including but not limited to dry compression packing method 250, can easily be adapted and adopted for packing of conventional chromatography media particles which have size (i.e. diameter) in the micrometer to tens of micrometer range, as well as nanoparticles.

In some embodiments, the chromatography media comprises hydroxyapatite microparticles. In some embodiments, the chromatography media powder comprises ceramic hydroxyapatite (CHT).

In some embodiments, a ceramic hydroxyapatite CHT (Type I) cuboid packed-bed 116 was formed using the method 250 disclosed herein. The CHT Type I media used had an average particles size of 40 μm, and this was packed within a square frame (20 mm×20 mm×12.5 mm inner dimension) by dry compression to obtain a cuboid packed-bed 116 having a volume of 5 mL. This frame was then sandwiched between a flow distribution plate 302 and a flow collection plate 304 to obtain the z² cuboid chromatography device 300. This chromatography device 300 was then assessed based on theoretical plate height measurement. Experimentally obtained plate height data was compared with data reported in the literature.

In some embodiments, the method 350 is used for assembling a chromatography device 300 for separation and/or purification of molecules in a fluid mixture.

In some embodiments, the method 350 is used for assembling a chromatography device 300 for separation and/or purification of biomolecules in a fluid mixture. In some embodiments, the method 350 is used for assembling a chromatography device 300 for bio-chromatography.

In some embodiments, the biomolecules comprise proteins.

In some embodiments, the biomolecules comprise viruses.

In some embodiments, the dry-compressed packed-bed 116 can be used as a reactor for chemical reactions when catalyst chromatography media is used.

In some embodiments, the method 350 is used for assembling a chromatography device 300 for performing chemical reactions.

### EXAMPLES

The following non-limiting examples are illustrative of the present disclosure:

### Materials and Methods

Materials: Hydroxyapatite (677418, nanopowder, <200 nm particle size), BSA (bovine albumin, A7906), lysozyme (L6876), sodium phosphate monobasic (S0751), and sodium phosphate dibasic (S0876) were purchased from Sigma-Aldrich (St. Louis, MO, USA). Sodium chloride (SOD002.205) was purchased from Bioshop (Burlington, ON, Canada). Monoclonal antibody Campath-1H was kindly donated by the Therapeutic Antibody Center, University of Oxford, Oxfordshire, UK. Monoclonal antibody Trastuzumab containing cell culture supernatant (lot: 20170920BC), produced using Chinese Hamster Ovary (CHO) cell line was kindly donated by the National Research Council Canada, Montreal, QC, Canada. A SIMPLICITY 185 water purification unit Millipore (Molsheim, France) was used for producing ultrapure water for buffer preparation. All buffers were filtered and degassed prior to use.

Set-up for dry-compression packing: FIG. 3A shows the different components of the set-up used for dry-compression packing of the hydroxyapatite nanoparticles. The punch, the frame extension, the frame and the base were all made of acrylic. The space within the frame had the following dimensions: 18.3 mm×18.3 mm×3 mm, i.e. the packed-bed 116 volume was 1 mL. The frame extension and the frame were first attached to the base using screws that were flush with the side of the frame extension facing outward. The combined space within the frame and the frame extension, i.e. the die, was filled with the hydroxyapatite nanoparticles, and it was levelled by gentle tapping. The punch was then lowered within the frame extension (FIG. 3B) and the assembly was placed within a vise. The nanoparticle packed-bed 116 was then dry-compressed by tightening the vise. The protruding portion of the punch had the same depth as the thickness of the frame extension (i.e. 5.7 mm). Therefore, the surface of the nanoparticle packed-bed 116 formed was flush with the frame. The pressure was released after 60 seconds and the dry-compression packing set-up was disassembled (FIG. 3C).

Flat z² cuboid device: The flat z² cuboid chromatography device 300 was assembled by sandwiching the framed dry-compressed packed-bed 116 between a top flow distribution plate 302, and a bottom flow collection plate 304 as shown in FIG. 4A. A retaining membrane 308 (0.1-micron microfiltration membranes) and gasket 306 (made of parafilm) were placed both below and above the framed dry-compressed packed-bed 116, as shown in FIG. 4A. The opening in the top and bottom gaskets matched the outline of the dry-compressed packed-bed 116, i.e. 18.3 mm×18.3 mm. The different components of the flat z² cuboid chromatography device 300 were held together using eight screws. FIG. 4B and FIG. 4C shows the detailed drawings of the top flow distribution plate 302, and a bottom flow collection plate 304. These were made of acrylic and each contained at least one engraved primary channel 310 (2 mm wide and 0.25 mm deep) and a set of secondary channels 312 (0.5 mm wide and 0.25 mm deep). The primary channel 310 in the two plates were located at slight offset from the packed-bed 116, whereas the set of secondary channels 312 were located above and below to the packed-bed 116. The outer dimension of the top and bottom flow plates matched the outer dimension of the frame, i.e. 42 mm×42 mm. As can be seen in FIG. 4B and FIG. 4C, the layout of the primary channel 310 and set of secondary channels 312 in the top flow distribution plate 302 and the bottom flow collection plate 304 were complimentary, to obtain the “z²” flow pattern in the flat z² cuboid chromatography device 300 to facilitate efficient flow distribution and collection [27, 28]. FIG. 4D shows the photograph of the assembled flat z² cuboid chromatography device 300 containing the packed-bed 116 of hydroxyapatite nanoparticles. As shown in FIG. 4D, the inlet and the outlet of the chromatography device 300 were located at space diagonally opposite ends. The chromatography device 300 was provided with two vents for priming and removing air bubbles.

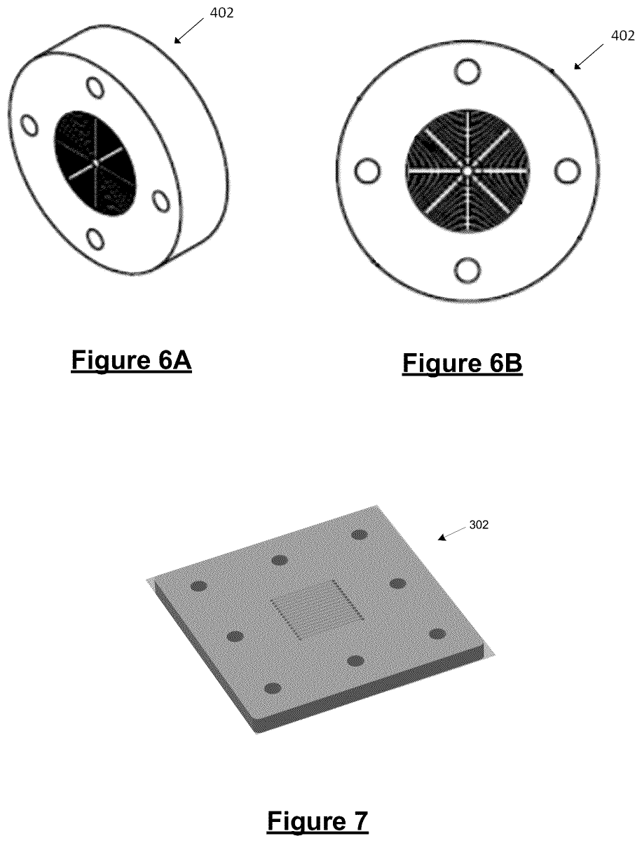

Flat column: The performance of the flat z² cuboid chromatography device 300 was compared with a 1 mL hydroxyapatite nanoparticle packed flat conventional axially-fed column chromatography device 300 having a bed height of 3 mm (i.e., the same as the z² cuboid chromatography device 300), and a diameter of 20.65 mm. This flat column was assembled using a circular header 402 plate with a diameter of 44.35 mm on either side, see FIG. 6A and FIG. 6B, for flow distribution and collection respectively, and a circular frame (see FIG. 2A and FIG. 2B) for housing the compressed packed-bed 116. The flat column was packed with the hydroxyapatite nanoparticles using the same method 350 as that used for the flat z² cuboid chromatography device 300, i.e., by dry compression, using its corresponding circular punch and frame extension. Circular gaskets and membrane discs (0.1-micron pore size) were used to retain the nanoparticles within the flat column.

Chromatography experiments: The hydroxyapatite nanoparticle-containing flat z² cuboid device or the flat column was integrated with an AKTA prime liquid chromatography system (GE Healthcare Biosciences, QC, Canada). The system dead-volume, including volume of tubing, connectors, and detectors, as estimated using tracer experiments, was about 0.15 mL. Tracer dispersion experiments were carried out using BSA as unbound protein, and phosphate buffered saline (pH 7.4) as mobile phase. The binding buffer used for the protein separation experiments was 5 mM sodium phosphate (pH 6.5). After equilibrating with the binding buffer to obtain stable UV and conductivity baselines, the protein samples were injected using appropriately sized loops (depending on the experiment). In all the protein separation experiments carried out, the bound protein was eluted by step change from 0 to 100% eluting buffer (5 mM sodium phosphate, pH 6.5+1 M sodium chloride). All chromatography experiments were carried out in triplicate.

SDS-Polyacrylamide gel electrophoresis: Eluate sample collected during the experiment carried out to purify monoclonal antibody Trastuzumab from mammalian cell culture supernatant was analyzed by 10% non-reducing SDS-polyacrylamide gel electrophoresis [41] and the gel was stained with Coomassie brilliant blue dye.

CHT dry compression: CHT ceramic hydroxyapatite multimodal chromatography media (Type I, 40 μm particle size, product number 1570040) was sourced from Bio-Rad Laboratories (Canada) Ltd, Mississauga, ON.

The dry-compression method 250 used to pack the CHT media is summarized in FIG. 2. The set-up used for dry-compression consisted of a base, a frame, a frame extension, and a punch. All these components were made of acrylic. The frame and frame extension were first attached to the base. The combined hollow space within the frame and frame extension was filled with CHT media (3.15 g). The punch was lowered into the space within the frame extension and the media was compressed by application of pressure (using a vise clamp). The dry-compression set-up was disassembled and the frame containing the dry-compressed packed-bed 116 was carefully removed. The CHT Type I dry-compressed packed-bed 116 had a volume of 5 mL (20 mm×20 mm×12.5 mm).

The frame containing the CHT Type I dry-compressed packed-bed 116 was sandwiched between a flow distribution plate 302 and a flow collection plate 304 which were made by 3D printing. FIG. 7 shows the distribution plate 302 with a primary channel 310 having circular cross-section (embedded within the body of the plate) and a set of secondary channels 312 having segment shaped cross-section (visible in FIG. 7) for flow distribution. The primary channel and set of secondary channels 312 in the flow collection plate 304 were complimentary to those in the flow distribution plate 302. As discussed previously [42, 27], such complimentary arrangement of channels was chosen for efficient flow distribution to the cuboid packed-bed 116 and collection from it.

The z² cuboid chromatography device 300 containing the CHT Type I media was evaluated based on theoretical plates measurement. These experiments were carried out using an AKTA Prime Plus liquid chromatography system (GE Healthcare Biosciences, QC, Canada). The mobile phase used in these experiments was 10 mM sodium phosphate (pH 6.0), while the tracer solution used was 1.75 M sodium chloride (prepared in mobile phase). The volume of pulse injected for obtaining the salt peaks (monitored using conductivity) was 100 μL (2% of bed-volume).

### Results and Discussion

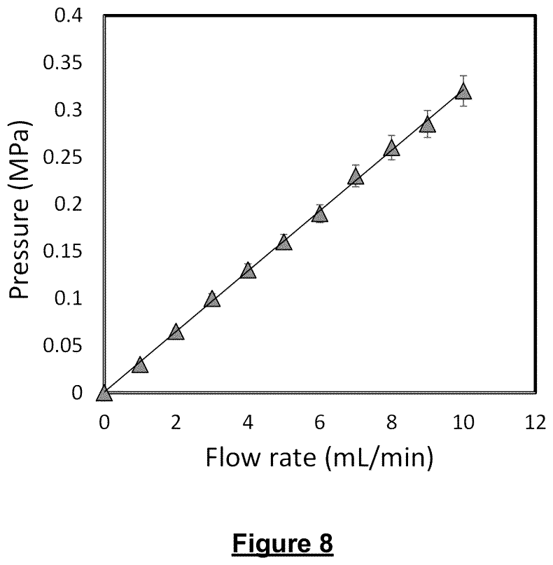

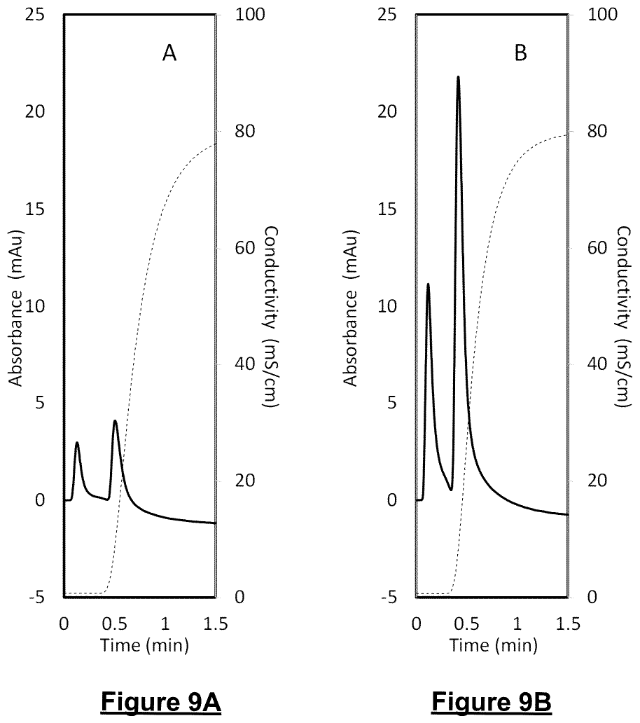

Preliminary experiments were carried out to determine the amounts of hydroxyapatite nanoparticles required to prepare the packed-bed 116. The amount was increased in steps of 0.1 g from a minimum value of 0.2 g. Below 0.5 g, the packed-bed 116 obtained were not very stable, and disintegrated when the dry-compression set-up was disassembled. The amount of hydroxyapatite nanoparticles was then increased (from 0.5 g) by smaller amounts. In each case, the frame was assembled within the z² cuboid chromatography device 300, which was then connected to the liquid chromatography system to check for stability. Stability was tested by gradually increasing the flow rate of 5 mM sodium phosphate (pH 6.5) buffer, in steps of 2 mL/min (from a minimum of 2 mL/min to a maximum of 10 mL/min), and then decreasing it again in similar step sizes. At each flow rate, the pressure was measured and linearity between flow rate and pressure was checked. The minimum mass of hydroxyapatite nanoparticles required for obtaining a stable compressed bed was found to be 0.7125 g. The force required to compress the packed-bed 116 was estimated to be about 24.5 N applied over an area of cross section of 3.35×10⁻⁴ m². To check for reproducibility, the chromatography device 300 was packed three times and the back pressure corresponding to different rate of buffer flow through the chromatography device 300 was recorded. FIG. 8 shows the pressure drop at different buffer flow rates (average of three data sets) for the flat z² cuboid chromatography device 300 packed with 0.7125 g of hydroxyapatite nanoparticles. The pressure changed linearly with the change in flow rate in the range examined. These results indicated that the nanoparticle packed-bed 116 housed within the flat z² cuboid chromatography device 300 was stable and was not likely to compact during the chromatography experiments. Also, even at very high flow rates, the pressure drop was quite low. The 1 mL flat column was packed with 0.7125 g of hydroxyapatite nanoparticles using the same dry-compression protocol as that used for the 1 mL flat z² cuboid chromatography device 300. This flat column had a diameter of 20.65 mm and a bed-height of 3 mm. While the low bed-height made it possible to operate this flat column at a low pressure-drop, its very large diameter-to-heigh ratio was expected to result in severe macro-scale convective dispersion [27, 28, 43], which is one of the main contributing factors for peak broadening in wide columns. The extent of macro-scale convective dispersion in the 1 mL flat z² cuboid chromatography device 300, and the 1 mL flat column was compared using BSA as unbound protein tracer. In these experiments, which were carried out at 2 mL/min flow rate, phosphate buffered saline (PBS), pH 7.4 was used as the mobile phase. The BSA concentration in the tracer solution was 5 mg/mL, and 10 microlitres of the tracer solution was injected to obtain the BSA flow-through peaks. The peak width at half height obtained with the 1 mL flat z² cuboid chromatography device 300 and the 1 mL flat column were found to be 0.506 mL and 0.625 mL respectively. Both these devices contained the same amount of hydroxyapatite nanoparticles (i.e., 0.7125 g), had the same bed-height (i.e., 3 mm), had the same area of cross-section, and were packed using the same dry-compression protocol. Therefore, at the same flow rate, the extent of eddy dispersion, axial diffusion,

and resistance to mass transfer [44] in each hydroxyapatite nanoparticle packed-bed 116 housed within the two devices could be expected to be similar. The only difference between the two was that one was a conventional axially fed column, while the other was a cuboid device with z² flow distribution and collection [27, 28]. The lower tracer dispersion observed with the 1 mL flat z² cuboid chromatography device 300 (as indicated by the smaller tracer peak width) could be explained based on the lower macro-scale convective dispersion in this chromatography device 300 [27, 28]. Therefore, better separation performance (compared to that with the flat column) could be expected with it. Hence, all further separation experiments were carried out using the 1 mL flat z² chromatography device 300.

Hydroxyapatite is considered a mixed-mode chromatographic media due

to the combination of mechanisms by which it binds different proteins [45]. The calcium ligand on hydroxyapatite is referred to as the C-site and it binds proteins through a metal ion affinity binding mechanism. The phosphate ligand present in hydroxyapatite is referred to as the P-site and it binds proteins through a cation exchange mechanism. At neutral pH, lysozyme binds to the P-site on hydroxyapatite [21, 43]. FIG. 9 shows the chromatograms obtained during separation of model proteins BSA and lysozyme using the 1 mL hydroxyapatite flat z² cuboid chromatography device 300 in the bind and elute mode. The binding buffer used in this experiment was 5 mM sodium phosphate (pH 6.5). BSA did not bind on hydroxyapatite and appeared as flow-through peak. Lysozyme, which did bind, was eluted by a step change to the eluting buffer (1 M sodium chloride prepared in 5 mM sodium phosphate, pH 6.5). The experiments shown in FIG. 9 were both carried out at a flow rate of 8 mL/min, using a feed sample consisting of 2 mg/mL BSA and 0.5 mg/mL lysozyme, prepared in the binding buffer. The chromatogram shown in FIG. 9A was obtained by injecting 10 μL of feed sample while the chromatogram shown in FIG. 9B was obtained by injecting 100 μL of feed sample. In both experiments, the two protein peaks (of BSA and lysozyme, respectively) were separated at the baseline, and both these separations took less than a minute.

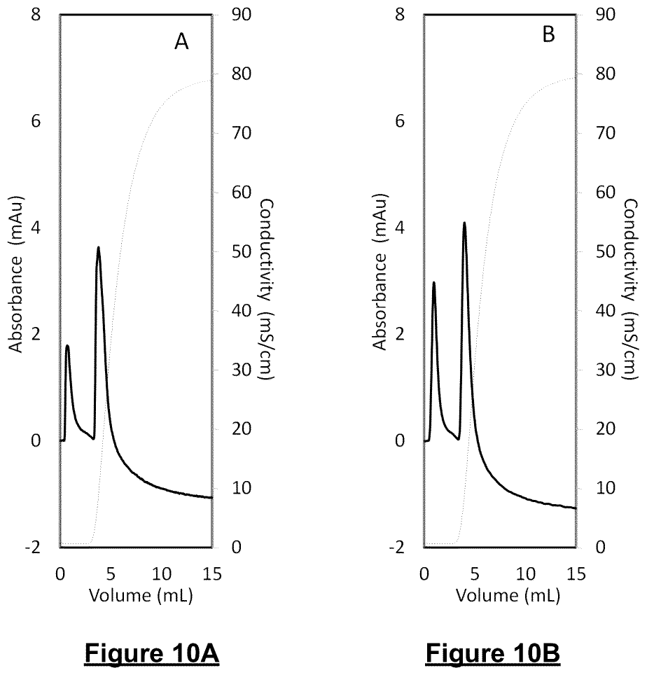

The effect of flow rate on the separation of BSA and lysozyme using the 1 mL hydroxyapatite flat z² cuboid chromatography device 300 was first examined by injecting 10 μL of feed sample. These experiments were carried out at flow rates of 2 and 8 mL/min. FIG. 10A and 10B show the chromatograms for lysozyme/BSA separation at flow rates of 2 mL/min and 8 mL/min, respectively. Both chromatograms (i.e. FIG. 10A and FIG. 10B) are shown with the volume axis (instead of the time axis) for ease of comparison. Both peaks (i.e. for BSA and lysozyme) were sharper and narrower at 8 mL/min flow rate, indicating that dispersion effects were lower, at the higher of the two flow rates. Table 1 shows a comparison of the width at half height for the flow-through (BSA) and the eluted lysozyme peaks obtained at the two flow rates examined. Consistent with visual comparison of the chromatograms shown in FIGS. 10A and FIG. 10B, the widths of the flow-through and eluted peaks decreased with increase in flow rate. Peak sharpness is critically important in chromatography. In preparative bind and elute separations such as the ones discussed in this disclosure, the sharpness of flow through and eluted peaks affect the speed and productivity of process. A sharper flow through peak makes it possible to initiate the elution step earlier. Also, a sharp peak ensures that the product collected in the pooled fraction is not diluted.

Table 2 summarizes the pressure drop data obtained during the BSA-lysozyme separation experiments discussed in the previous paragraph. As expected, the pressure at 8 mL/min flow rate was approximately four time that observed at 2 mL/min flow rate. The pressure drop during the binding step was slightly higher than that during elution. This was probably due to the added hydraulic resistance offered by the hydroxyapatite-bound protein molecules. A comparison of the pressure data shown in Table 2 with the pressure drop data shown in FIG. 8 indicated the significant hydraulic resistance offered by the sample loop. For instance, the pressure drop without the sample loop at a flow rate of 8 mL/min was 0.26 MPa. By contrast, the pressure drop at the same flow rate when the sample loop was in-line was 0.65 MPa.

TABLE 1
Effect of flow rate on peak width at half height for BSA (flow
through) and lysozyme (eluted) peaks (media: 200 nm hydroxyapatite
nanopowder; bed volume: 1 mL; feed: 2 mg/mL BSA + 0.5 mg/mL
lysozyme; sample loop: 10 μL; step change to eluting buffer;
binding buffer: 5 mM sodium phosphate (pH 6.5); eluting buffer:
5 mM sodium phosphate (pH 6.5) + 1M sodium chloride; peak
width data based on experiments run in triplicate).

| Flow rate | BSA peak width at | Lysozyme peak width |
|---|---|---|
| (mL/min) | half height (mL) | at half height (mL) |
| 2 | 0.712 = 0.003 | 0.908 ± 0.006 |
| 8 | 0.605 = 0.004 | 0.712 ± 0.009 |

TABLE 2
Effect of flow rate and mobile phase composition during binding
and elution on pressure drop across the 1 mL flat z² cuboid
chromatography device 300 (media: 200 nm hydroxyapatite nanopowder;
bed volume: 1 mL; feed: 2 mg/mL BSA + 0.5 mg/mL lysozyme;
sample loop: 10 μL; step change to eluting buffe; binding
buffer: 5 mM sodium phosphate (pH 6.5); eluting buffer: 5
mM sodium phosphate (pH 6.5) + 1M sodium chloride; pressure
data based on experiments run in triplicate).

| Flow rate | Pressure during | Pressure during |
|---|---|---|
| (mL/min) | binding (MPa) | elution (MPa) |
| 2 | 0.16 = 0.02 | 0.15 ± 0.03 |
| 8 | 0.65 = 0.08 | 0.62 ± 0.06 |

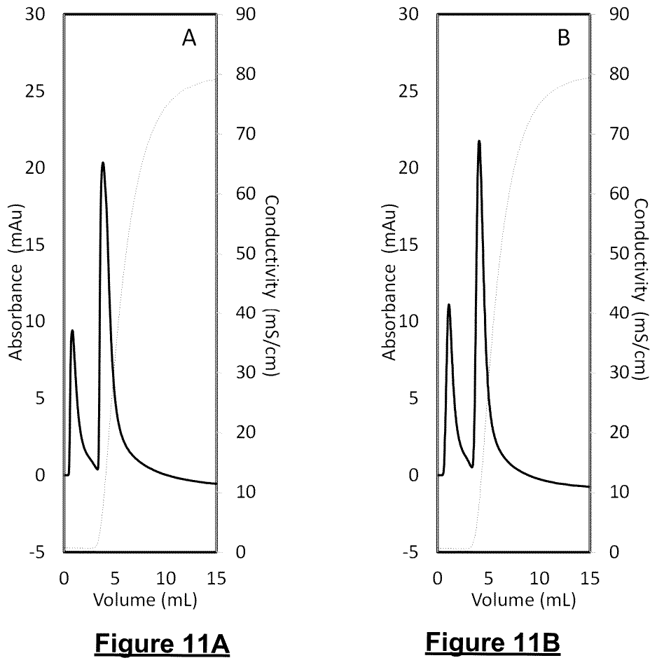

The effect of flow rate on the separation of BSA and lysozyme was then studied by injecting 100 μL of feed sample at flow rates of 2 and 10 mL/min. (see FIG. 11A and FIG. 11B, respectively). Consistent with the results shown in FIG. 10A and FIG. 10B, sharper and narrower peaks were obtained at the higher of the two flow rates (i.e., 10 mL/min in this case). Table 3 summarizes the BSA and lysozyme peak width data obtained at the two flow rates examined. Once again, consistent with the results shown in Table 1, the peak widths decreased with increase in flow rate.

TABLE 3
Effect of flow rate on peak width at half height for BSA (flow
through) and lysozyme (eluted) peaks (media: 200 nm hydroxy
apatite nanopowder; bed volume: 1 mL; feed: 2 mg/mL BSA +
0.5 mg/mL lysozyme; sample loop: 100 μL; step change to eluting
buffer; binding buffer: 5 mM sodium phosphate (pH 6.5); eluting
buffer: 5 mM sodium phosphate (pH 6.5) + 1M sodium chloride;
peak width data based on experiments run in triplicate).

| Flow rate | BSA peak width at | Lysozyme peak width |
|---|---|---|
| (mL/min) | half height (mL) | at half height (mL) |
| 2 | 0.745 = 0.004 | 1.034 ± 0.007 |
| 10 | 0.689 = 0.005 | 0.833 ± 0.008 |

The effect of flow rate on chromatographic separations could be explained based on the van Deemter equation for the height equivalent of a theoretical plate (HETP) [44]:

$$HETP = A + \frac{B}{u} + C u$$

wherein HETP is the height equivalent of a theoretical plate, A is the eddy dispersion term, B is the axial diffusion term, C is the resistance to mass transfer term and u is the superficial velocity, which is obtained by dividing the flow rate by the area of cross-section of the packed-bed 116. By the rule of thumb, the greater the value of HETP, the poorer the resolution. When macromolecules such as proteins are separated using soft and porous resin particles having diameter in the several tens of micron range, the third term dominates, i.e. the resolution decreases with increase in superficial velocity (and therefore with increase in the flow rate) [45]. This is because the main resistance to mass transfer takes place within the pores present within the resin particles. Also, axial diffusion plays a relatively minor role (except at very low superficial velocities) as the diffusivity of macromolecules such as proteins is low. However, in the experiments carried out using the 1 mL hydroxyapatite flat z² cuboid chromatography device 300, the scenario was different. To begin with, the hydroxyapatite nanoparticles used in this study were significantly smaller (i.e. <200 nm). Also, these nanoparticles were made of crystalline material (manufacturer's information) and did not have pores, i.e. the binding took place only on the outer surface of these particles. Based on these factors, it would be safe to assume that the resistance to mass transfer in the packed-bed 116 of the hydroxyapatite nanoparticles would be negligibly small. Also, in packed-beds consisting of nonporous ultrafine particles, with very small inter-particle space, increasing the flow rate could actually increase the mass transfer coefficient, i.e. resistance to mass transfer would decrease. Such increase in efficiency with increase in flow rate has been reported in membrane chromatography [46], where the scenario is somewhat similar to that in the nanoparticle packed flat z² cuboid chromatography device 300, i.e., there is very low resistance to mass transfer. The flat z² cuboid chromatography device 300 had a relatively large cross-sectional area compared to conventional columns of similar volume. On account of this, the frontal area of a solute band travelling though this chromatography device 300 would be significantly larger than that in a conventional column. This would increase the extent of axial diffusion, i.e. the contribution of the second term of the van Deemter equation would be more significant than that of the third. Therefore, increasing the flow rate would diminish the second term. This explains why, when using the 1 mL hydroxyapatite nanoparticle flat z² cuboid chromatography device 300, shaper peaks were obtained at higher flow rates.

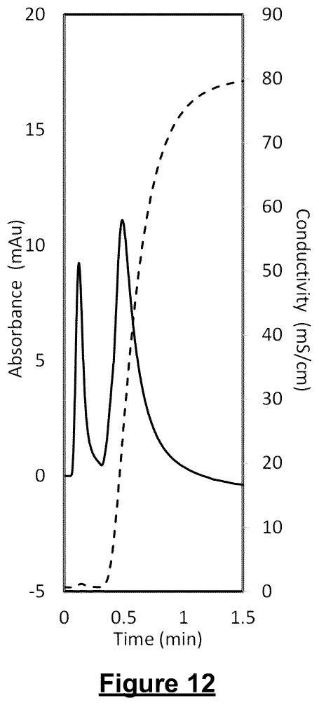

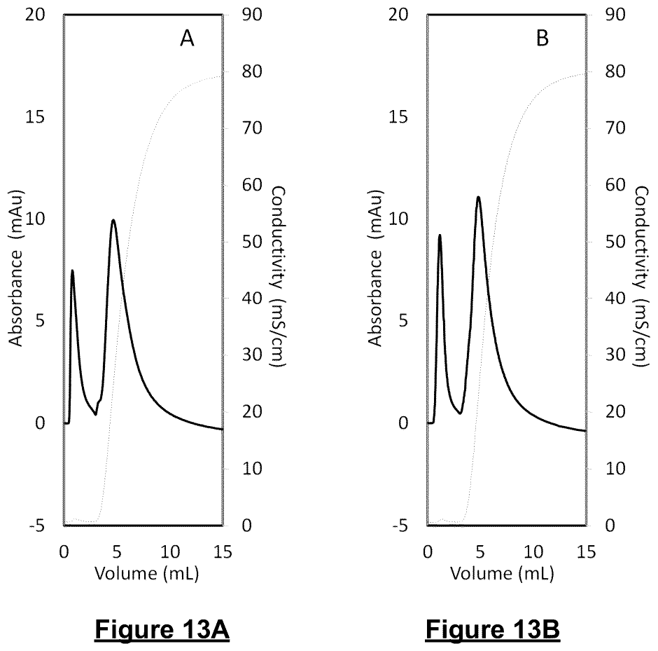

The separation of monoclonal antibodies using hydroxyapatite chromatography has been widely reported [17, 18, 47]. The antibody molecule binds to hydroxyapatite primarily on the P-site by cation exchange mechanism, while the binding on the C-site has a secondary role [47]. FIG. 12 shows the chromatogram obtained during the separation of monoclonal antibody Campath-1H from BSA using the 1 mL hydroxyapatite nanoparticle flat z² cuboid chromatography device 300. In this experiment, 5 mM sodium phosphate (pH 6.5) was used as the binding buffer, while 1 M sodium chloride solution prepared in 5 mM sodium phosphate (pH 6.5) was used as eluting buffer. The feed solution consisted of 1 mg/mL Campath-1H and 2 mg/mL BSA, prepared in the binding buffer. The experiment was carried out at a flow rate of 10 mL/min by injecting 100 μL of feed sample. BSA was obtained as a flow through peak, while the bound monoclonal antibody was eluted using a step change to eluting buffer. Almost baseline separation of the two protein was obtained in a minute. FIG. 13A and FIG. 13B shows the chromatograms for BSA/Campath-1H separation obtained with the 1 mL hydroxyapatite nanoparticle flat z² cuboid chromatography device 300 at flow rates of 2 mL/min and 10 mL/min respectively. Both chromatograms are shown with volume axis to enable comparison. Table 4 summarizes widths of the BSA and Campath-1H peaks at the two flow rates examined. Like that observed with BSA/lysozyme separation (see Table 1 and Table 3), the width of the BSA and Campath-1H peaks decreased with increase in flow rate.

TABLE 4
Effect of flow rate on peak width at half height for BSA (flow
through) and Campath-1H (eluted) peaks (media: 200 nm hydroxyapatite
nanopowder; bed volume: 1 mL; feed: 2 mg/mL BSA + 1 mg/mL
Campath-1H; sample loop: 100 μL; elution: step change to eluting
buffer; binding buffer: 5 mM sodium phosphate (pH 6.5); eluting
buffer: 5 mM sodium phosphate (pH 6.5) + 1M sodium chloride;
peak width data based on experiments run in triplicate).

| Flow rate | BSA peak width at | Campath-1H peak width |
|---|---|---|
| (mL/min) | half height (mL) | at half height (mL) |
| 2 | 0.717 ± 0.003 | 2.066 ± 0.009 |
| 10 | 0.665 ± 0.005 | 1.770 ± 0.007 |

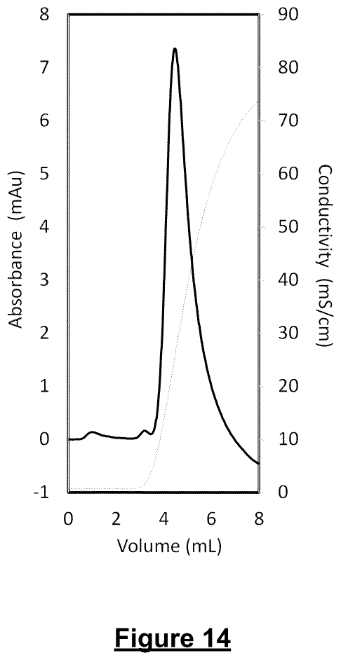

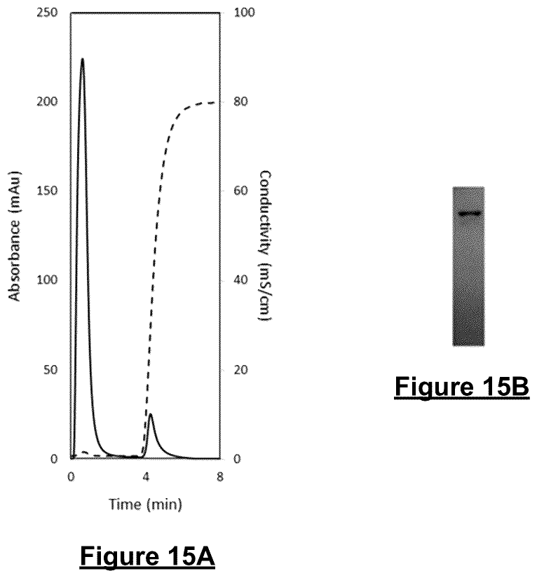

FIG. 14 shows the bind-and-elute chromatogram obtained with the 1 mL hydroxyapatite nanoparticle flat z² cuboid chromatography device 300 by injecting 100 μL of protein-A purified Trastuzumab solution (0.6 mg/mL in 5 mM sodium phosphate, pH 6.5). This experiment was carried out at a flow rate of 8 mL/min using 5 mM sodium phosphate (pH 6.5) as binding buffer and 1 M sodium chloride solution prepared in 5 mM sodium phosphate (pH 6.5) as eluting buffer. As can be seen, the monoclonal antibody bound to hydroxyapatite and could be eluted using a step change to eluting buffer. In order to purify Trastuzumab from mammalian cell culture supernatant, microfiltered (through 0.2-micron membrane) supernatant was diluted 1 in 10 using the above binding buffer. Trastuzumab purification using the 1 mL hydroxyapatite nanoparticle flat z² cuboid chromatography device 300 was carried out at 4 mL/min flow rate, by injecting 2 mL of the diluted cell culture supernatant. The bound Trastuzumab was eluted using a step change to 1 M sodium chloride solution prepared in 5 mM sodium phosphate (pH 6.5). The chromatogram obtained is shown in FIG. 15. The impurities were removed in the flow-through peak (0.7 mL retention volume), and Trastuzumab was obtained in the eluted peak having ˜16 mL retention volume. Therefore, this preparative separation could be completed in about 6 minutes. The Trastuzumab obtained was highly enriched, as evident from the non-reducing SDS-PAGE gel (inset FIG. 15), which shows one major band. The above results provide preliminary evidence for the suitability of the hydroxyapatite nanoparticles packed flat z² cuboid chromatography device 300 for monoclonal antibody purification.

The above results demonstrate that the disclosed dry-compression method 250 is suitable for packing hydroxyapatite nanoparticles in a packing-bed 116 for the 1 mL flat z² cuboid chromatography device 300. The method 250 is simple, and the use of the flat z² cuboid format (with 3 mm bed-height) made it possible to carry out chromatographic separations at quite low pressures. Also, the flat and wide format of the packed-bed made it particularly suitable for dry-compression packing. Compression of nanoparticles in long column-like structures would be lot more difficult. The dry-compression method 250 worked well for the scale examined, i.e. 1 mL bed-volume. At this scale, the compression protocol, and set-up were uncomplicated. However, when scaling up to process scale, both protocol, and set-up, may need to be modified to suite the specific requirement of the pertinent scale. Addition of inert binders could aid in the compression process. There is a wealth of information on powder compression and consolidation available in the literature, in the areas of pharmaceutics [48] and materials science [49], which could be leveraged upon for such scale-up.

Fast and high-resolution separation of proteins could be carried out using the 1 mL hydroxyapatite nanoparticle packed flat z² cuboid chromatography device 300. The typical time required for binary protein separation of different model proteins was about a minute. Due to the negligible resistance to mass transfer in the nanoparticle packed-bed 116, the widths of the flow through and eluted protein peaks decreased with increase in flow rate. This made it possible to simultaneously maximize both productivity and purity. The efficiency of separation using the flat z² cuboid chromatography device 300 may be improved, for example by changing dimensions and/or arrangement of the primary channel 310 and set of secondary channels 312 to minimize macro-scale convective dispersion, and chromatography device 300 void volume. While this study focused primarily on monoclonal antibody purification and analysis, the purification of other difficult to purify proteins can also be performed using a chromatography device 300 with packed-bed 116 packed using the disclosed method 250. Furthermore, other types of chromatographic media may be dry-packed using the disclosed method 250 to form a packed-bed 116, which could then be used to develop high-speed, purification and/or reaction processes.

CHT dry compression: The experiments for determining theoretical plate height were carried out at four different flow rates, i.e., 1, 3, 5 and 7 mL/min. Each experiment was run in triplicate. The number of theoretical plates (N) was determined based on peak retention volume (V_{R}), and peak width at half height (w_{0.5}) using the following equation:

$$N = 5.545 {( \frac{{V}_{R}}{{w}_{0.5}} )}^{2}$$

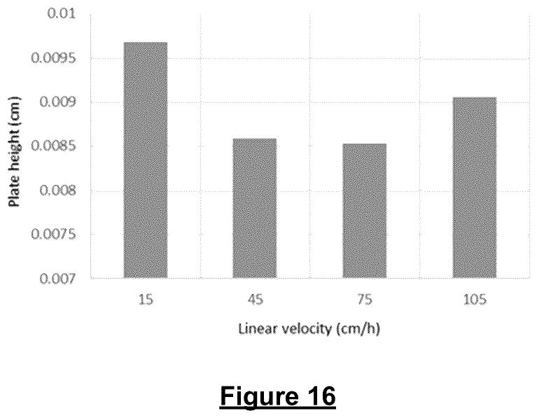

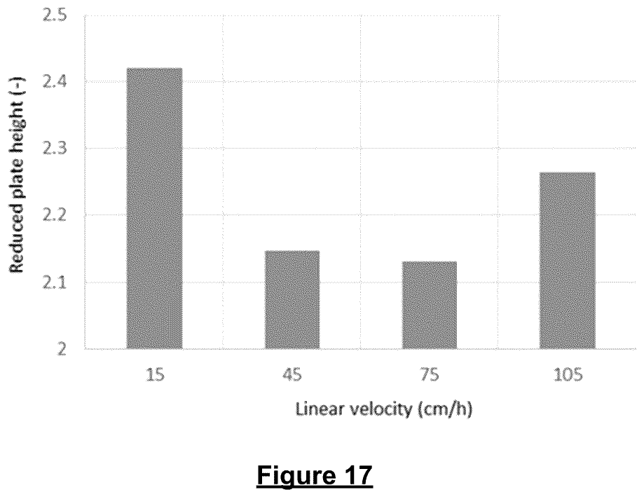

The height equivalent of a theoretical plate (HETP) was calculated by dividing the bed-height (12.5 mm) by N. The reduced plate height (H) was obtained by dividing HETP by the average diameter of the CHT Type I particles (40 μm). FIG. 16 shows the effect of linear velocity (obtained by dividing the flow rate by the area of cross-section) on HETP while FIG. 17 shows the effect of linear velocity on H. The data shows that the lower value of HETP (and H) was obtained at a linear velocity of 75 cm/h. This corresponded to flow rate of 5 mL/min. The HETP values shown in FIG. 16 were compared with those reported by the manufacturer for the same media, albeit packed in cylindrical columns [22]. For a linear velocity range of 75 to 90 cm/hr, the manufacturer-reported range for HETP of CHT Type I particles (40 μm) is 0.016-0.021 cm. The data shown in FIG. 16 indicated that at a linear velocity of 75 cm/h, the HETP value obtained with the z² cuboid chromatography device 300 containing the CHT Type I media was 0.0085 cm. By the rule of thumb, a lower HETP value indicated better efficiency in chromatographic separation. Hence, not only was the dry-compression method 250 suitable for packing CHT Type I media, but separation also obtained with the z² cuboid chromatography device 300 packed with this media could be expected to be better that that obtained with the cylindrical column packed with the same media. In the same source [50], the manufacturer indicated that a H value of less than 5.5 was acceptable. FIG. 17 indicated that at a linear velocity of 75 cm/h, the H value obtained with the z² cuboid chromatography device 300 containing the CHT Type I media was 2.13. Hence, the efficiency of the CHT Type I media dry-compressed packed in the z² cuboid chromatography device 300 exceeded the manufacturer's requirement by a significant extent.

Nanoparticle chromatographic media is suitable for high-resolution protein separations. However, such media is difficult to pack within conventional chromatography columns. Particularly, slurry packing of columns with very fine particles is extremely difficult. Also, any chromatography column packed with nanoparticles would need to be operated at extremely high pressures. The disclosed dry-compression method 250 was simple and was found to be suitable for packing hydroxyapatite nanoparticles within a flat z² cuboid chromatography device 300. The use of these nanoparticle in the flat z² cuboid format, with a bed-height of 3 mm, allowed separations to be carried out at quite low pressures. The results discussed herein demonstrate that 1 mL hydroxyapatite nanoparticle flat z² cuboid chromatography device 300 was suitable for carrying out fast, separation of proteins. Binary protein separation in the bind and elute mode could be carried out in about a minute. The widths of the flow through and eluted peaks decreased with increase in flow rate. This could be attributed to the negligible resistance to mass transfer in the nanoparticle packed-bed 116. This attribute, i.e. potential for higher resolution at higher flow rates is particularly attractive, as it makes it possible to simultaneously maximize both productivity and purity. The 1 mL hydroxyapatite nanoparticle flat z² cuboid chromatography device 300 was also found to be suitable for carrying out preparative purification of monoclonal antibody Trastuzumab from mammalian cell culture supernatant in the bind and elute mode. This approach of dry-packing fine-particle chromatographic media in a flat cuboid chromatography device 300 could be used to develop both analytical and preparative chromatography devices that combine high-resolution with high-speed.

Furthermore, the results clearly demonstrate the suitability and benefits of packing CHT media as an example of conventional micron sized media using the dry-compression packing method 250. The method 250 is simple and reproducible and does not require high level of operator expertise. Also, very precise mass of media can be packed using this method 250. The performance of the dry-packed media (in terms of HETP and H) was way superior to that specified by the manufacturer of the CHT media for use in column.

While the present disclosure has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present disclosure is found to be defined differently in a document incorporated herein by reference, the definition provided herein is to serve as the definition for the term.

### REFERENCES

1. J. J. Kirkland, J. J. DeStefano, The art and science of forming packed analytical high-performance liquid chromatography columns, J. Chromatogr. A, 1126 (2006) 50-57.
2. P. A. Bristow, P. N. Brittain, C. M. Riley, B. F. Williamson, Upward slurry packing of liquid chromatography columns. Journal of Chromatography A, 131 (1977) 57-64.
3. W. M. Farooq, D. C. Patel, R. M. Wimalasinghe, D. W. Armstrong, Fundamental and practical insights on the packing of modern high-efficiency analytical and capillary columns, Anal. Chem., 89 (2017) 8177-8191.
4. G. Guiochon, M. Sarker, Consolidation of the packing material in chromatographic columns under dynamic axial compression. I. Fundamental study, J. Chromatogr. A 704 (1995) 247-268.
5. M. Dorn, F. Eschbach, D. Hekmat, D. Weuster-Botz, Influence of different packing methods on the hydrodynamic stability of chromatography columns, J. Chromatogr. A 1516 (2017) 89-101.
6. M. Dorn, D. Hekmat, Simulation of the dynamic packing behavior of preparative chromatography columns via discrete particle modeling, Biotechnol. Prog. 32 (2016) 363-371.
7. A. Martinez, K. Knaub, M. Monter, D. Hekmat, D. Weuster-Botz, Improved packing of preparative biochromatography columns by mechanical vibration, Biotechnol. Prog. 36 (2020) e2950.
8. P. A. Bristow, J. H. Knox, Standardization of test conditions for high performance liquid chromatography columns, Chromatographia, 10 (1977) 279-289.
9. A. Jungbauer, Chromatographic media for bioseparation, J. Chromatogr. A 1065 (2005) 3-12.
10. K. D. Patel, A. D. Jerkovich, J. C. Link, J. W. Jorgenson, In-depth characterization of slurry packed capillary columns with 1.0-μm nonporous particles using reversed-phase isocratic ultrahigh-pressure liquid chromatography, Anal. Chem. 76 (2004) 5777-5786.
11. F. Gritti, G. Guiochon, The current revolution in column technology: How it began, where is it going?, J. Chromatogr. A 1228 (2012) 2-19.
12. F. Gritti, G. Guiochon, On the extra-column band-broadening contributions of modern, very high pressure liquid chromatographs using 2.1 mm I.D. columns packed with sub-2 μm particles, J. Chromatogr. A. 1217 (2010) 7677-7689.
13. F. Gritti, M. Martin, G. Guiochon, Influence of Viscous Friction Heating on the Efficiency of Columns Operated under Very High Pressures, Anal. Chem. 81 (2009) 3365-3384.
14. S. Fekete, K. Ganzler, D. Guillarme, Critical evaluation of fast size exclusion chromatographic separations of protein aggregates, applying sub-2 μm particles, J. Pharm. Biomed. Anal. 78-79 (2013) 141-149.
15. A. Colman, M. J. Byers, S. B. Primrose, A. Lyons, Rapid purification of plasmid DNAs by hydroxyapatite chromatography, Eur. J. Biochem. 91 (1978) 303-310.
16. M. R. Urist, Y. K. Huo, A. G. Brownell, W. M Hohl, J. Buyske, A. Lietze, P. Tempst, M. Hunkapiller, R.J. DeLange, Purification of bovine bone morphogenetic protein by hydroxyapatite chromatography, Proc. Nat. Acad. Sci. 81(1984) 371-375.
17. P. Gagnon, Improved antibody aggregate removal by hydroxyapatite chromatography in the presence of polyethylene glycol, J. Immunol. Meth. 336 (2008) 222-228.
18. Y. Wang, G. Carta, Separation of monoclonal antibody monomer-dimer mixtures by gradient elution with ceramic hydroxyapatite, J. Chromatogr. A 1629 (2020) 461465.
19. M. P. Ferraz, F. J. Monteiro, C. M. Manuel, Hydroxyapatite nanoparticles: a review of preparation methodologies, J. Appl. Biomater. Biomech. 2 (2004) 74-80.
20. J. Krenkova, N. A. Lacher, F. Svec, Control of selectivity via nanochemistry: monolithic capillary column containing hydroxyapatite nanoparticles for separation of proteins and enrichment of phosphopeptides, Anal. Chem. 82 (2010) 8335-8341.
21. G. Chen, I. Zhitomirsky, R. Ghosh, Fast, low-pressure chromatographic separation of proteins using hydroxyapatite nanoparticles, Talanta, 199 (2019) 472-477.
22. P Madadkar, Q Wu, R Ghosh, A laterally-fed membrane chromatography module, J. Membr. Sci., 487 (2015) 173-179.
23. R. Ghosh, Using a box instead of a column for process chromatography, J. Chromatogr. A, 1468 (2016) 164-172.
24. R Ghosh, P Madadkar, Laterally-fed membrane chromatography device, U.S. Pat. No. 10,758,841 (2020).
25. R Ghosh, P Madadkar, Laterally-fed membrane chromatography device, U.S. Pat. No. 10,758,840 (2020).
26. R. Ghosh, Chromatography device and method for filtering a solute from a fluid, U.S. Pat. No. 10,759,829 (2020).
27. R Ghosh, G Chen, U Umatheva, P Gat, A flow distribution and collection feature for ensuring scalable uniform flow in a chromatography device, J. Chromatogr. A, 1618 (2020) 460892.
28. R Ghosh, P Gat, U Umatheva, G Chen, Flow distribution and collection features for ensuring scalable uniform flow in a chromatography or membrane separation device, U.S. patent application Ser. No. 16/987,845 (2020).
29. P. Gagnon, Monoclonal antibody purification with hydroxyapatite, New Biotechnol., 25 (2009) 287-293.
30. Y. Wang, G. Carta, Competitive binding of monoclonal antibody monomer-dimer mixtures on ceramic hydroxyapatite, J. Chromatogr. A, 1587 (2019) 136-145.
31. Y. Wang, G. Carta, G., 2020. Separation of monoclonal antibody monomer-dimer mixtures by gradient elution with ceramic hydroxyapatite. J. Chromatogr. A, 1629 (2020) 461465.
32. Y. Zhang, L. Cai, Y. Wang, Y. Li, Y., Processing of high-salt-containing protein A eluate using mixed-mode chromatography in purifying an aggregation-prone antibody, Protein Expr. Purif, 164 (2019) 105458.
33. C. L. Morrison, P. Gagnon, S. M. Cramer, Purification of monomeric mAb from associated aggregates using selective desorption chromatography in hydroxyapatite systems, Biotechnol. Bioeng., 108 (2011) 813-821.
34. J. O. Baek, J. W. Seo, I. H. Kim, C. H. Kim, Production and purification of human papillomavirus type 33 L1 virus-like particles from Spodoptera frugiperda 9 cells using two-step column chromatography, Protein Expr. Purif, 75 (2011) 211-217.
35. Y. Kurosawa, S. Sato, T. Okuyama, M. Taoka, M., 2019. Sequential two-step chromatographic purification of infectious poliovirus using ceramic fluoroapatite and ceramic hydroxyapatite columns. PloS One, 14 (2019) e0222199.
36. F. Hilbrig, R. Freitag, Isolation and purification of recombinant proteins, antibodies and plasmid DNA with hydroxyapatite chromatography, Biotechnol. J., 7 (2012) 90-102.
37. O. Kaltenbrunner, S. Cao, E. Freydell, N. Keener, L. Zhu, N. Jiao, B. Williamson, M. A. Snyder, L. J. Cummings, L. J., 2012. Monitoring ceramic hydroxyapatite media degradation using dynamic image analysis and uniaxial confined bulk compression, Biotechnol. J., 7 (2012) 1288-1296.
38. A. Jungbauer, Chromatographic media for bioseparation, J. Chromatogr. A 1065 (2005) 3-12.
39. P. Gagnon, K. Beam, Antibody aggregate removal by hydroxyapatite chromatography, Curr. Pharm. Biotechnol., 10 (2009) 440-446.
40. L. J. Cummings, M. A. Snyder, K. Brisack, Protein chromatography on hydroxyapatite columns, Meth. Enzymol., 463 (2009) 387-404.
41. U. Laemmli, Cleavage of structural proteins during the assembly of the head of bacteriophage T4, Nature. 227 (1970) 680-685.
42. R. Ghosh, G. Hale, Y. Durocher, P. Gatt, Dry-compression packing of hydroxyapatite nanoparticles within a flat cuboid chromatography device and its use for fast protein separation, J. Chromatogr. A, 1667 (2022) 462881.
43. T. Kawasaki, Hydroxyapatite as a liquid chromatographic packing, J. Chromatogr. A 544 (1991) 147-184.
44. J. J. van Deemter, F. J. Zuiderweg, A. Klinkenberg, Longitudinal diffusion and resistance to mass transfer as causes of nonideality in chromatography, Chem. Eng. Sci. 5 (1956) 271-289.
45. G. Chen, R. Roshankhah, R. Ghosh, A cuboid chromatography device having short bed-height gives better protein separation at a significantly lower pressure drop than a taller column having the same bed-volume, J. Chromatogr. A (2021) in press, 462167.
46. R. Ghosh, G. Chen, R. Roshankhah, U. Umatheva, P. Gat, A z² laterally-fed membrane chromatography device for fast high-resolution purification of biopharmaceuticals, J. Chromatogr. A 1629 (2020) 461453.
47. F. Hilbrig, R. Freitag, Isolation and purification of recombinant proteins, antibodies and plasmid DNA with hydroxyapatite chromatography, Biotechnol. J. 7 (2012) 90-102.
48. K. Kawakita, K. H. Ltidde, Some considerations on powder compression equations, Powder Technol. 4 (1971) 61-68.
49. K. T. Kim, S. W. Choi, H. Park, Densification behavior of ceramic powder under cold compaction, J. Eng. Mater. Technol., 122 (2000) 238-244.
50. CHT™ Ceramic Hydroxyapatite Instruction Manual, Bio-Rad Laboratories Inc., https://www.bio-rad.com/webroot/web/pdf/lsr/literature/LIT611E.PDF (accessed Aug. 16, 2022).

What is claimed is:

1. A packing assembly for forming a packed-bed for a chromatography device, the packing assembly comprising:
a bottom plate;
a first top plate defining a top plate hole centrally positioned in the first top plate;
a middle plate defining a middle plate hole centrally positioned in the middle plate, the middle plate hole being aligned with the top plate hole when the packing assembly is in an assembled state where the middle plate is coupled to each of the bottom plate and the first top plate and the middle plate is positioned between the bottom plate and the first top plate; and
a second top plate having a protrusion extending outwardly, at least a portion of the protrusion having a same size and a same shape as the top plate hole to be received in the top plate hole when the packing assembly is in a packing state.

2. The packing assembly of claim 1, wherein the protrusion has an upper end and a lower end, the lower end having a lower surface that is coplanar with a lower surface of the first top plate when the packing assembly is in the packing state.

3. The packing assembly of claim 2, wherein the lower surface of the protrusion is parallel with an upper surface of the bottom plate when the packing assembly is in the packing state.

4. The packing assembly of claim 1, wherein the protrusion has a height equal to a thickness of the first top plate.

5. The packing assembly of claim 1, wherein the middle plate hole in the middle plate, the top plate hole in the first top plate, and the protrusion in the second top plate are rectangular or square.

6. The packing assembly of claim 1, wherein the middle plate hole in the middle plate, the top plate hole in the first top plate, and the protrusion in the second top plate are circular.

7. The packing assembly of claim 1, wherein the middle plate hole has a diameter of about 10 mm to about 500 mm.

8. A method of packing chromatography media in a packing assembly to form a packed-bed, the method comprising:
a) placing the chromatography media in the packing assembly when the packing assembly is in an assembled state, the packing assembly comprising
a bottom plate;
a first top plate defining a top plate hole centrally positioned in the first top plate;
a middle plate defining a middle plate hole centrally positioned in the middle plate, the middle plate hole being aligned with the top plate hole when the packing assembly is in the assembled state where the middle plate is coupled to each of the bottom plate and the first top plate and the middle plate is positioned between the bottom plate and the first top plate; and
a second top plate having a protrusion extending outwardly, at least a portion of the protrusion having a same size and a same shape as the top plate hole to be received in the top plate hole when the packing assembly is in a packing state;
b) inserting the protrusion of the second top plate into the top plate hole; and
c) applying a force to the second top plate to put the packing assembly into the packing state and compress the chromatography media into the middle plate hole to form the packed-bed in the middle plate.

9. The method of claim 8, wherein applying the force to the second top plate compresses the chromatography media between a lower end of the protrusion and an upper surface of the bottom plate, the lower end of the protrusion and the upper surface of the bottom plate being parallel with each other.

10. The method of claim 8, wherein applying the force to the second top plate provides for the packed-bed to have a thickness that is less than its length and/or width and/or diameter.

11. The method of claim 8, wherein applying the force to the second top plate provides for the packed-bed to a volume of about 0.1 mL to about 1000 mL.

12. The method of claim 8, wherein the force applied to the second top plate is about 10 N to about 100 N.

13. The method of claim 8, wherein the chromatography media comprises nanoparticles and/or microparticles.

14. The method of claim 8, wherein the chromatography media comprises Sephadex, Amberlite, silica gel, aluminum oxide and/or hydroxyapatite.

15. The method of claim 8, wherein the chromatography media is hydroxyapatite.

16. A method of assembling a chromatography device, the method comprising:
a) placing the chromatography media in the packing assembly, the packing assembly comprising
a bottom plate;
a middle plate defining a middle plate hole centrally positioned in the middle plate;
a first top plate defining a top plate hole centrally positioned in the first top plate, the middle plate being aligned with the top plate hole when the packing assembly is in the assembled state where the middle plate is coupled to each of the bottom plate and the first top plate and the middle plate is positioned between the bottom plate and the first top plate; and
a second top plate having a protrusion extending outwardly, at least a portion of the protrusion having a same size and same shape as the top plate hole to be received in the top plate hole when the packing assembly is in a packing state;
b) inserting the protrusion of the second top plate into the top plate hole;
c) applying a force to the second top plate to put the packing assembly into the packing state and compress the chromatography media in the middle plate hole to form the packed-bed in the middle plate;
d) disassembling the packing assembly to separate the middle plate from the bottom plate and the first top plate; and
e) placing the middle plate with the packed-bed in the chromatography device.

17. The method of claim 16, wherein the chromatography device comprises a laterally-fed membrane chromatography device.

18. The method of claim 16, wherein the chromatography device comprises an axially-fed membrane chromatography device.

19. The method of claim 16, wherein the method is used for assembling a chromatography device for separation and/or purification of molecules in a fluid mixture.

20. The method of claim 16, wherein the method is used for assembling a chromatography device for performing chemical reactions.
